(19) United States
(12) Patent Application Publication
(10) Pub. No.: US 2024/0203222 A1
(43) Pub. Date: Jun. 20, 2024

(54) DETECTING AN OBJECT IN AN ENVIRONMENT

(71) Applicant: Essence Security International (E.S.I.) Ltd., Herzlia Pituach (IL)

(72) Inventors: Ohad AMIR, Herzlia (IL); Jonathan Mark SCHNAPP, Tel Aviv (IL); Ran ROSENBLUM, Petach Tikva (IL); Gregory MORAV, RaAnana (IL)

(21) Appl. No.: 18/555,710

(22) PCT Filed: Apr. 18, 2022
(86) PCT No.: PCT/IL2022/050402

§ 371 Date: Oct. 16, 2023

(30) Foreign Application Priority Data
Apr. 19, 2021 (IL) 282448

(51) Int. Cl. G08B 13/196; G08B 13/24

(52) U.S. Cl. CPC G08B 13/19695; G08B 13/19613; G08B 13/1966; G08B 13/19663; G08B 13/2491

(57) ABSTRACT

One embodiment relates to an apparatus for detecting an object in an environment, the apparatus comprising: a camera controllable to switch from a first to a second mode to prepare the camera to capture an image; a processor, wherein the processor is arranged to receive motion detection data associated with a first monitoring region in said environment, and measured wave reflection data associated with a second monitoring region obtained by an active reflected wave detector, wherein the first monitoring region includes at least part of the second monitoring region and extends beyond the second monitoring region in at least one direction. In response to the processor detecting motion in the first monitoring region, the processor is configured to: activate the active reflected wave detector; determine whether a predetermined condition is met; if the condition is met, perform at least one operation related to camera image data.

### BACKGROUND

Motion sensors are designed to monitor a defined area, which may be outdoors (e.g., entrance to a building, a yard, and the like), and/or indoors (e.g., within a room, in proximity of a door or window, and the like). Motion sensors may be used for security purposes, to detect intruders based on motion in areas in which no motion is expected, for example, an entrance to a home at night.

Some security systems employ a motion sensor in the form of a passive infrared (PIR) detector to sense the presence of a heat-radiating body (i.e., such a heat-radiating body would typically indicate the presence of an unauthorized person) in its field of view, and then issue a deterrent such as an audible alarm sound.

### SUMMARY

The inventors have identified that using a motion sensor to trigger the capture of an image by a camera based on the motion sensor detecting motion can cause a lot of false triggers. This is because a motion sensor such as a PIR detector is unable to identify where in its field of view a moving object is or what the moving object is (e.g, whether it is a human or animal). These false triggers result in the power intensive process of the camera capturing an image of the monitored environment, or performing an action in response to a captured image, when it is not needed. This is particularly undesirable for battery powered systems where available power is limited.

Some embodiments of the present disclosure relate to mechanisms which advantageously conserve power of the device.

According to one aspect of the present disclosure there is provided an apparatus for detecting an object in an environment, the apparatus comprising: a camera, wherein the camera is controllable to switch from a first mode to a second mode to prepare the camera to capture an image; and a processor, wherein the processor is arranged to receive motion detection data associated with a first monitoring region in said environment, and measured wave reflection data associated with a second monitoring region that is obtained by an active reflected wave detector, wherein the first monitoring region includes at least part of the second monitoring region and extends beyond the second monitoring region in at least one direction; wherein in response to the processor detecting motion in the first monitoring region based on said motion detection data, the processor is configured to: activate the active reflected wave detector; determine whether a predetermined condition is met based on processing the measured wave reflection data; and if the predetermined condition is met, perform at least one operation related to camera image data.

According to another aspect of the present disclosure there is provided a computer implemented method for detecting an object in an environment, the method comprising: receiving motion detection data associated with a first monitoring region in said environment; in response detecting motion in the first monitoring region based on said motion detection data, the method further comprising: activating an active reflected wave detector; receiving measured wave reflection data associated with a second monitoring region obtained by the active reflected wave detector, wherein the first monitoring region includes at least part of the second monitoring region and extends beyond the second monitoring region in at least one direction; determining whether a predetermined condition is met based on processing the measured wave reflection data; and if the predetermined condition is met, performing at least one operation related to camera image data.

According to another aspect of the present disclosure there is provided a non-transitory computer-readable storage medium comprising instructions which, when executed by a processor that is coupled to an active reflected wave detector that is operable to measure wave reflections from the environment, causes the processor to: receive motion detection data associated with a first monitoring region in said environment;
detect motion in the first monitoring region based on said motion detection data, and in response: activate the active reflected wave detector; receive measured wave reflection data associated with a second monitoring region obtained by the active reflected wave detector, wherein the first monitoring region includes at least part of the second monitoring region and extends beyond the second monitoring region in at least one direction; determine whether a predetermined condition is met based on processing the measured wave reflection data; and if the predetermined condition is met, performing at least one operation related to camera image data.

According to another aspect of the present disclosure there is provided an apparatus for detecting an object in an environment, the apparatus comprising: a camera, wherein the camera is controllable to switch from a first mode to a second mode to prepare the camera to capture an image; and a processor configured to: determine whether a predetermined condition is met based on processing measured wave reflection data obtained by an active reflected wave detector, the measured wave reflection data associated with wave reflections from a first monitoring region in said environment; and
if the predetermined condition is met, perform at least one operation related to camera image data; wherein the processor is further configured to: process measured wave reflection data that is associated with wave reflections from a second monitoring region in said environment to detect a predefined condition comprising that the object has left the second monitoring region, and in response to detection of the predefined condition cause the camera to switch from the second mode to a mode that consumes less power than the second mode.

According to another aspect of the present disclosure there is provided a computer implemented method for detecting an object in an environment, the method comprising: receiving measured wave reflection data obtained by an active reflected wave detector; determining whether a predetermined condition is met based on processing measured wave reflection data that is associated with wave reflections from a first monitoring region in said environment; if the predetermined condition is met, performing at least one operation related to camera image data; and processing measured wave reflection data that is associated with wave reflections from a second monitoring region in said environment to detect a predefined condition comprising that the object has left the second monitoring region, and in response to detection of the predefined condition causing a camera, which is controllable to switch from a first mode to a second mode to prepare the camera to capture an image, to switch from the second mode to a mode that consumes less power than the second mode.

According to another aspect of the present disclosure there is provided a non-transitory computer-readable storage medium comprising instructions which, when executed by a processor that is coupled to an active reflected wave detector that is operable to measure wave reflections from an environment, causes the processor to: receive measured wave reflection data obtained by the active reflected wave detector; determine whether a predetermined condition is met based on processing measured wave reflection data that is associated with wave reflections from a first monitoring region in said environment; if the predetermined condition is met, perform at least one operation related to camera image data; and process measured wave reflection data that is associated with wave reflections from a second monitoring region in said environment to detect a predefined condition comprising that the object has left the second monitoring region, and in response to detection of the predefined condition cause a camera, which is controllable to switch from a first mode to a second mode to prepare the camera to capture an image, to switch from the second mode to a mode that consumes less power than the second mode.

According to another aspect of the present disclosure there is provided an apparatus for detecting an object in an environment, the apparatus comprising: a processor coupled to at least one sensing device, the at least one sensing device configured to output a first type of sensor signal and a second type of sensor signal to the processor wherein the second type is different to the first type, the at least one sensing device comprising an active reflected wave detector that is operable to measure wave reflections from said environment to detect said object and output said first type of sensor signal, the processor configured to: receive an input that defines a desired region of interest in respect of the active reflected wave detector; and determine whether at least one part of the desired region extends beyond predefined limits, the predefined limits being correlated with viewable region limits associated with the at least one sensing device outputting said second type of sensor signal.

According to another aspect of the present disclosure there is provided a computer implemented method for detecting an object in an environment, the method comprising:
receiving an input that defines a desired region of interest in respect of an active reflected wave detector that is operable to measure wave reflections from said environment to detect said object and output a first type of sensor signal; and determining whether at least one part of the desired region extends beyond predefined limits, the predefined limits being correlated with viewable region limits associated with at least one sensing device outputting a second type of sensor signal, wherein the second type is different to the first type, the at least one sensing device comprising said active reflected wave detector.

According to another aspect of the present disclosure there is provided a non-transitory computer-readable storage medium comprising instructions which, when executed by a processor, that is coupled to at least one sensing device that is configured to output a first type of sensor signal and a second type of sensor signal to the processor wherein the second type is different to the first type, the at least one sensing device comprising an active reflected wave detector that is operable to measure wave reflections from said environment to detect said object and output said first type of sensor signal, causes the processor to: receive an input that defines a desired region of interest in respect of the active reflected wave detector; and determine whether at least one part of the desired region extends beyond predefined limits, the predefined limits being correlated with viewable region limits associated with the at least one sensing device outputting said second type of sensor signal.

The instructions referred to above may be provided on one or more carriers. For example there may be one or more non-transient memories, e.g. a EEPROM (e.g. a flash memory) a disk, CD- or DVD-ROM, programmed memory such as read-only memory (e.g. for Firmware), one or more transient memories (e.g. RAM), and/or a data carrier(s) such as an optical or electrical signal carrier. The memory/memories may be integrated into a corresponding processing chip and/or separate to the chip. Code (and/or data) to implement embodiments of the present disclosure may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language.

These and other aspects will be apparent from the embodiments described in the following. The scope of the present disclosure is not intended to be limited by this summary nor to implementations that necessarily solve any or all of the disadvantages noted.

### BRIEF DESCRIPTION OF THE SEVERAL VIEWS OF THE DRAWINGS

For a better understanding of the present disclosure and to show how embodiments may be put into effect, reference is made to the accompanying drawings in which:

FIG. 1 illustrates system comprising an environment in which a device has been positioned;

FIG. 2 is a schematic block diagram of the device;

FIG. 3 illustrates a human body with indications of reflections measured by an active reflected wave detector of the device;

FIG. 4 illustrates a process for detecting an object in an environment according to a first embodiment of the present disclosure;

FIG. 5 illustrates a process for detecting an object in an environment according to another embodiment of the present disclosure;

FIG. 6a illustrates an example relationship between a motion detection monitoring region and a radar monitoring region;

FIGS. 6b and 6c illustrates an example whereby a user has defined a radar region of interest that is within the radar monitoring region;

FIG. 7a illustrates an example whereby a camera control monitoring region is the same as the radar monitoring region;

FIG. 7b illustrates an example whereby a camera control monitoring region is the same as a radar region of interest within the radar monitoring region;

FIGS. 7c and 7d illustrates an example whereby a camera control monitoring region extends beyond a radar region of interest;

FIG. 7e illustrates an example whereby a larger camera control monitoring region extends beyond the camera control monitoring region, and the larger camera control monitoring region is the radar monitoring region;

FIGS. 7f and 7g illustrates an example whereby a larger camera control monitoring region extends beyond the camera control monitoring region, and the larger camera control monitoring region is within the radar monitoring region; and

FIG. 8 illustrates a process for configuring the device.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized, and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims and their equivalents. In the following embodiments, like components are labelled with like reference numerals.

In the following embodiments, the term data store or memory is intended to encompass any computer readable storage medium and/or device (or collection of data storage mediums and/or devices). Examples of data stores include, but are not limited to, optical disks (e.g., CD-ROM, DVD-ROM, etc.), magnetic disks (e.g., hard disks, floppy disks, etc.), memory circuits (e.g., EEPROM, solid state drives, random-access memory (RAM), etc.), and/or the like.

As used herein, except wherein the context requires otherwise, the terms “comprises”, “includes”, “has” and grammatical variants of these terms, are not intended to be exhaustive. They are intended to allow for the possibility of further additives, components, integers or steps.

The functions or algorithms described herein are implemented in hardware, software or a combination of software and hardware in one or more embodiments. The software comprises computer executable instructions stored on computer readable carrier media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, microcontroller or other type of processing device or combination thereof.

Specific embodiments will now be described with reference to the drawings.

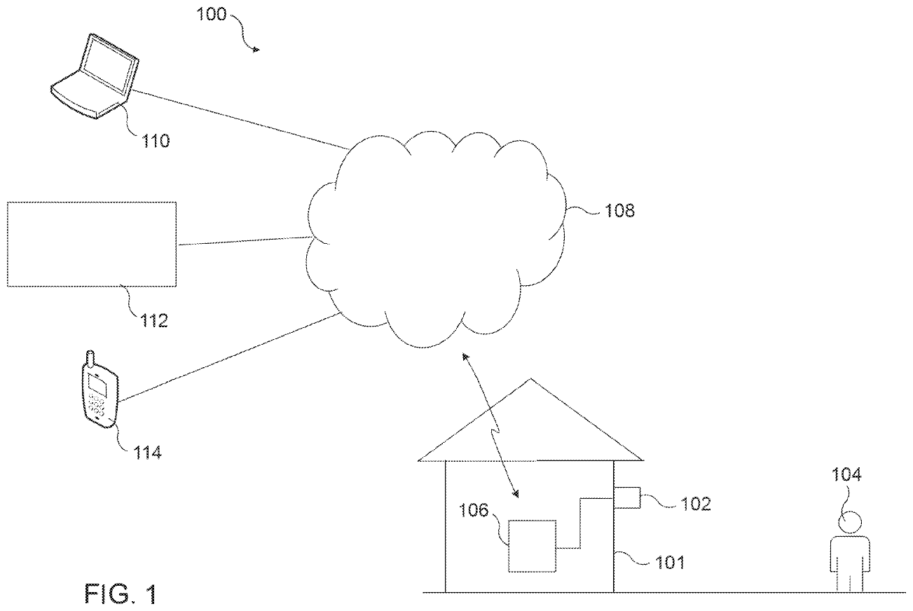

FIG. 1 illustrates a system 100 comprising an environment in which a device 102 has been positioned. The environment may for example be an outdoor space such as an area outside of a residential property (e.g. a yard) or commercial property, or a public space (e.g. train station). Alternatively, the environment may be an indoor space such as a room of a home, a public building or other indoor space. The device 102 is mounted to a building 101 or other structure.

The device 102 is configured to monitor the environment in which a target object (e.g. a person 104) may be present.

As shown in FIG. 1, the device 102 may be coupled to a remote device by way of a wired and/or wireless connection. In particular the device 102 may be coupled, preferably wirelessly, to a hub device 106 (otherwise referred to herein as a control hub), which may be in the form of a control panel.

The control hub 106 may transmit data to a remote monitoring station 110 over a network 108. An operator at the remote monitoring station 110 responds as needed to incoming notifications triggered by the device 102 and may also respond to incoming notifications triggered by other similar devices which monitor other environments. In other embodiments, the device 102 may transmit data to the remote monitoring station 110 without interfacing with the control hub 106. In both examples, the data from the device 102 may be sent (from the device 102 or control hub 106) directly to the remote monitoring station 110 or via a remote server 112. The remote monitoring station 110 may be for example a laptop, notebook, desktop, tablet, smartphone or the like.

Additionally or alternatively, the control hub 106 may transmit data to a remote personal computing device 114 over a network 108. A user of the remote personal computing device 114 is associated with the environment monitored by the device 102, for example the user may be the home owner of the environment being monitored, or an employee of the business whose premises are being monitored by the device 102. In other embodiments, the device 102 may transmit data to the remote personal computing device 114 without interfacing with the control hub 106. In both examples the data from the device 102 may be sent (from the device 102 or control hub 106) directly to the remote personal computing device 114 or via the server 112. The remote personal computing device 114 may be for example a laptop, notebook, desktop, tablet, smartphone or the like.

The remote server 112 may, in some embodiments, receive the data and decide whether to forward corresponding data and/or may decide the destination(s), e.g. the monitoring station 102 and/or device 114, to which to forward the corresponding data. Further, in some embodiments the data from the device 102 may be sent directly to the server, e.g. using a cellular communications protocol. By contrast, communications from device 102 to control hub 102 may be via wired communication protocol or non-cellular wireless communications protocol, for example as Wi-Fi, Zigbee, Bluetooth or a proprietary or other short or medium range wireless protocol.

The network 108 may be any suitable network which has the ability to provide a communication channel between the device 102 and/or the control hub 106 to the remote devices 110, 112, 114.

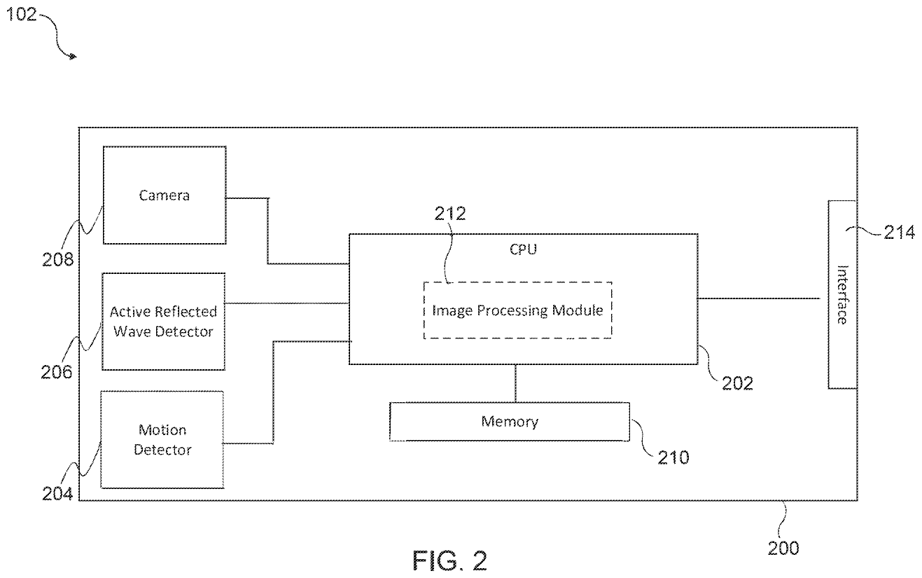

FIG. 2 illustrates a simplified view of the device 102. A shown in FIG. 2, the device 102 comprises a central processing unit (“CPU”) 202, to which is connected a memory 210. The functionality of the CPU 202 described herein may be implemented in code (software) stored on a memory (e.g. memory 210) comprising one or more storage media, and arranged for execution on a processor comprising on or more processing units. The storage media may be integrated into and/or separate from the CPU 202. The code is configured so as when fetched from the memory and executed on the processor to perform operations in line with embodiments discussed herein. Alternatively, it is not excluded that some or all of the functionality of the CPU 202 is implemented in dedicated hardware circuitry (e.g. ASIC(s), simple circuits, gates, logic, and/or configurable hardware circuitry like an FPGA. In other embodiments (not shown) a processing system executes the processing steps described herein, wherein the processing system may consist of the processor as described herein or may be comprised of distributed processing devices that may be distributed across two or more devices shown in the system 100. Each processing device of the distributed processing devices may comprise any one of more of the processing devices or units referred to herein.

FIG. 2 shows the CPU 202 being connected to a motion sensor 204, an active reflected wave detector 206, and a camera 208. While in the illustrated embodiment the motion sensor 204, active reflected wave detector 206, and the camera 208 are separate from the CPU 202, in other embodiments, at least part of processing aspects of the motion sensor 204 and/or active reflected wave detector 206 and/or camera 208 may be provided by a processor that also provides the CPU 202, and resources of the processor may be shared to provide the functions of the CPU 202 and the processing aspects motion sensor 204 and/or active reflected wave detector 206 and/or camera 208. Similarly, functions of the CPU 202, such as those described herein, may be performed in the motion sensor 204 and/or the active reflected wave detector 206 and/or the camera 208.

In an activated state (e.g. a higher power consumption operating mode) the active reflected wave detector 206 operates to measure wave reflections from the environment. In some embodiments, the active reflected wave detector 206 may consume more power in the activated state (i.e, when turned on and operational) than the motion sensor 204 does when in an activated state.

As shown in FIG. 2, a housing 200 of the device 102 may house the motion sensor 204, the active reflected wave detector 206 and the camera 208. Alternatively, the motion sensor 204 may be external to the device 102 and be coupled to the CPU 202 by way of a wired or wireless connection. Similarly, the active reflected wave detector 206 may be external to the device 102 and be coupled to the CPU 202 by way of a wired or wireless connection. Similarly, the camera 208 may be external to the device 102 and be coupled to the CPU 202 by way of a wired or wireless connection. Further, the outputs of the motion sensor 204 and/or active reflected wave detector 206 and/or camera 208 may be wirelessly received from/via an intermediary device that relays, manipulates and/or in part produces their outputs, for example the control hub 106.

In embodiments, the CPU 202 is configured to detect motion in the environment based on an output of the motion sensor 204. The motion sensor 204 may be a passive infrared (PIR) sensor. The motion sensor is preferably a PIR sensor, however it could be an active reflected wave sensor, for example radar, that detects motion based on the Doppler effect. For example, the motion sensor 204 may be a radar based motion sensor which detects motion based on the Doppler component of a radar signal. The motion sensor 204 is configured to detect motion in a motion detection monitoring region in the environment. The lateral field of view of the motion sensor 204 may be between 100° and 120°. It will be appreciated that this angle range is merely an example, the lateral field of view of the motion sensor 204 may be up to 160° or higher. The motion detection monitoring region has a depth of field which is the distance between a minimum distance of the depth of field and a maximum distance of the depth of field. If an object is moving beyond the maximum distance of the depth of field of the motion detection monitoring region of the motion sensor 204, the motion sensor 204 will not detect this movement, or at least not as reliably (e.g. the motion sensor may not meet its performance specifications). Similarly, if an object is moving between the motion sensor 204 and the minimum distance of the depth of field the motion sensor 204 will not detect this movement, or at least not as reliably.

The active reflected wave detector 206 may operate in accordance with one of various reflected wave technologies. In operation, the CPU 202 uses the output of the active reflected wave detector 206 to determine the presence of a target object (e.g. human). The lateral field of view of the active reflected wave detector 206 may have a field of view of 160°.

The active reflected wave detector 206 may be a ranging detector. That is, in contrast with Doppler-only detectors, the active reflected wave detector 206 may be configured to determine the location of an object (e.g. a person) in its field of view. This enables the CPU 202 to track the location of an object in the environment.

In some implementations, the active reflected wave detector 206 may provide both a ranging based output and a Doppler-based output based on measuring wave reflections from the environment. In these implementations, the active reflected wave detector 206 is configured to detect motion in a motion detection monitoring region in the environment, and a dedicated motion sensor 204 is not required.

Preferably, the active reflected wave detector 206 is a radar sensor. The radar sensor 206 may use millimeter wave (mmWave) sensing technology. The radar is, in some embodiments, a continuous-wave radar, such as frequency modulated continuous wave (FMCW) technology. Such a chip with such technology may be, for example. Texas Instruments Inc, part number iwr6843AOP. The radar may operate in microwave frequencies, e.g. in some embodiments a carrier wave in the range of 1-100 GHz (76-81 Ghz or 57-64 GHz in some embodiments), and/or radio waves in the 300 MHz to 300 GHz range, and/or millimeter waves in the 30 GHz to 300 GHZ range. In some embodiments, the radar has a bandwidth of at least 1 GHz. The active reflected wave detector 206 may comprise antennas for both emitting waves and for receiving reflections of the emitted waves, and in some embodiment different antennas may be used for the emitting compared with the receiving.

The active reflected wave detector 206 is also associated with a “radar monitoring region”. The radar monitoring region is the region in the environment that the active reflected wave detector 206 observes, when operational, as may be defined by the radar's field of view and depth of view. It may therefore be alternatively termed “radar observing region”. The radar monitoring region may, for example, define the region in which objects are detectable by the radar. Thus the radar monitoring region may be referred to herein as the maximum region that the active reflected wave detector is configured to monitor. Such a maximum region is understood herein to be no greater than the region in which the active reflected wave detector is able to ensure that one or more minimum performance level requirements are met. The monitoring by the active reflected wave detector 206 (e.g. a radar) may be, or include, any one or more of observing, checking, or keeping a continuous record of reflective wave measurements (e.g. radar measurements). Further, there may be different parts of the radar monitoring region that are monitored in respectively different ways. For example, it may be that reflective wave measurements (e.g. radar measurements) are performed and tested against a certain condition for one part of the radar monitoring region, such as a region of interest, whereas reflective wave measurements (e.g. radar measurements) for another part of the radar monitoring region, such as the remaining area outside the region of interest, may merely be performed but then disregarded. The disregarding of such measurements may for example be because they are outside the region of interest. For example, the monitoring may comprise generating reflective wave measurements (e.g. radar measurements) for all of the radar monitoring region and subsequently reducing the set of measurements to be confined to a smaller area that is under surveillance. Thus the phrase “the maximum region that the active reflected wave detector is configured to monitor” may optionally be interchanged with the phrase “the region observed by the active reflected wave detector” or “the region for which the active reflected wave detector generates reflected wave measurements”.

The radar monitoring region has a depth of field which is the distance between a minimum distance of the depth of field and a maximum distance of the depth of field. If an object is present beyond the maximum distance of the depth of field of the radar monitoring region, the active reflected wave detector 206 will not detect the object. Similarly, if an object is present between the active reflected wave detector 206 and the minimum distance of the depth of field the active reflected wave detector 206 will not detect the object.

A user is also able to define one or more “radar region of interest” associated with the active reflected wave detector 206. A radar region of interest is, or is within, the radar monitoring region and is defined as a region that causes a certain action to be taken. This action that is performed may for example be that the object detected in the radar region of interest is tracked, and/or that an alarm is raised. The radar region of interest may correspond to a region defined by a virtual fence within the field of view of the active reflected wave detector 206. During installation of the device 102, the installer will switch the device to a calibration or configuration mode for the defining of the virtual fence. Exemplary methods for an installer to define such a virtual fence is described in International patent application number PCT/IL2020/050130, filed 4 Feb. 2020, the contents of which are incorporated herein by reference. However, other methods of defining a virtual fence may alternatively be employed. It will be appreciated that more than one virtual fence may be defined within the field of view of the active reflected wave detector 206. The region of interest may be defined on a case-by-case basis at installation, depending on the use case. e.g. the environment in which it is installed.

As will be appreciated the active reflected wave detector 206 is an “active” detector in the sense of it relying on delivery of waves from an integrated source in order to receive reflections of the waves. The active reflected wave detector 206 is not limited to being a radar sensor, and in other embodiments alternative ranging detectors may be used, for example the active reflected wave detector 206 may be a LIDAR sensor, or a sonar sensor.

Thus whilst we refer herein to a “radar region of interest” and a “radar monitoring region” such terms may more generally be substituted with “region of interest of the active reflected wave detector” and “monitoring region of the active reflected wave detector”, respectively.

The active reflected wave detector 206 being a radar sensor is advantageous over other reflected wave technologies in that radar signals may transmit through some materials, e.g, wood or plastic, but not others—notably water which is important because humans are mostly water. This means that the radar can potentially “see” a person in the environment even if they are behind an object of a radar-transmissive material. Depending on the material, this may not be the case for sonar or lidar.

Each of the motion sensor 204 and the active reflected wave detector 206 has a field of view. The motion sensor 204 and the active reflected wave detector 206 may be arranged such that their fields of view overlap. The fields of view of the motion sensor 204 and the active reflected wave detector 206 may partially or fully overlap. Thus there may be at least a partial overlap between the fields of view of the motion sensor 204 and the active reflected wave detector 206.

The overlapping, or partial overlapping, of the fields of view is, in some embodiments, in the 3D sense. However in other embodiments the overlapping, or partial overlapping, of the fields of view may be in a 2D, plan view, sense. For example, there may be an overlapping field of view in the X and Y axes, but with a non-overlap in the Z axis.

In some embodiments, the CPU 202 is configured to control the camera 208 to capture an image (represented by image data) of the environment. The camera 208 is preferably a visible light camera in that it senses visible light. Alternatively, the camera 208 senses infrared light. One example of a camera which senses infrared light is a night vision camera which operates in the near infrared (e.g, wavelengths in the range 0.7-1.4 μm) which requires infrared illumination e.g. using infrared LED(s) which is not visible to an intruder. Another example of a camera which senses infrared light is a thermal imaging camera which is passive in that it does not require an illuminator, but rather, senses light in a wavelength range (e.g. a range comprising 7 to 15 μm, or 7 to 11 μm) that includes wavelengths corresponding to blackbody radiation from a living person (around 9.5 μm). The camera 208 may be capable of detecting both visible light and, for night vision, near infrared light. As shown in FIG. 2, the CPU 202 may comprise an image processing module 212 for processing image data captured by the camera 208.

The camera 208 is also associated with a “camera viewable region” which is the region in the environment that the camera sees and can capture one or more images of the environment.

The lateral field of view of the camera viewable region may have a field of view of 140°, it will be appreciated that this is merely an example and other angles are possible. The camera viewable region has a depth of field which is the distance between a minimum distance of the depth of field and a maximum distance of the depth of field. If an object is present beyond the maximum distance of the depth of field of the camera viewable region, the object will be out of focus in a captured image. Similarly, if an object is present between the camera 208 and the minimum distance of the depth of field the camera 208 the object will be out of focus in a captured image.

The depth of field of the active reflected wave detector 206 and the camera viewable region may be much greater than that of the motion sensor 204, especially in embodiments in which the motion sensor is a PIR sensor.

The device 102 may comprise a communications interface 214 for communication of data to and from the device 102. For example, the device 102 may communicate with a remote device 106, 110, 112, 114 via the communications interface 214. Additionally or alternatively, the device 102 may communicate, via the communications interface 214, with one or more of the motion sensor 204, the active reflected wave detector 206, and the camera 208 in embodiments in which such components are not housed in the housing 200 of the device 102.

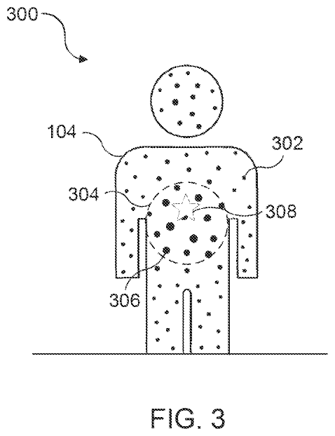

FIG. 3 illustrates a free-standing human body 104 with indications of reflective wave reflections therefrom in accordance with some embodiments.

For each reflected wave measurement, for a specific time in a series of time-spaced reflected wave measurements, the reflected wave measurement may include a set of one or more measurement points that make up a “point cloud”, the measurement points representing reflections from respective reflection points from the environment. In embodiments, the active reflected wave detector 206 provides an output to the CPU 202 for each captured frame as a point cloud for that frame. Each point 302 in the point cloud may be defined by a 3-dimensional spatial position from which a reflection was received, and defining a peak reflection value, and a Doppler value from that spatial position. Thus, a measurement received from a reflective object may be defined by a single point, or a cluster of points from different positions on the object, depending on its size.

In some embodiments, such as in the examples described herein, the point cloud represents only reflections from moving points of reflection, for example based on reflections from a moving target. That is, the measurement points that make up the point cloud represent reflections from respective moving reflection points in the environment. This may be achieved for example by the active reflected wave detector 206 using moving target indication (MTI). Thus, in these embodiments there must be a moving object in order for there to be reflected wave measurements from the active reflected wave detector (i.e. measured wave reflection data), other than noise Alternatively, the CPU 202 receives a point cloud from the active reflected wave detector 206 for each frame, where the point cloud has not had pre-filtering out of reflections from moving points. Preferably for such embodiments, the CPU 202 filters the received point cloud to remove points having Doppler frequencies below a threshold to thereby obtain a point cloud representing reflections only from moving reflection points. In both of these implementations, the CPU 202 accrues measured wave reflection data which corresponds to point clouds for each frame whereby each point cloud represents reflections only from moving reflection points in the environment.

In some embodiments, measured wave reflection data may comprise signals received from an array of transducers (e.g. antennas) and/or may be represented by analog or digital signals that precede a digital signal processing (dsp) component of the apparatus. For example, even in embodiments that generate a point cloud, the measured wave reflection data may be data that precedes calculation of the point cloud by the dsp component.

The region for which the radar is capable of identifying reflections of waves emitted from the active reflected wave detector is a way to define the radar monitoring region. This is consistent with the above description of the radar monitoring region being bound by a field of view and a depth of view.

In other embodiments, no moving target indication (or any filtering) is used. In these implementations, the CPU 202 accrues measured wave reflection data which corresponds to point clouds for each frame whereby each point cloud can represent reflections from both static and moving reflection points in the environment.

FIG. 3 illustrates a map of reflections. The size of the point represents the intensity (magnitude) of energy level of the radar reflections (see larger point 306). Different parts or portions of the body reflect the emitted signal (e.g. radar) differently. For example, generally, reflections from areas of the torso 304 are stronger than reflections from the limbs. Each point represents coordinates within a bounding shape for each portion of the body. Each portion can be separately considered and have separate boundaries. e.g. the torso and the head may be designated as different portions. The point cloud can be used as the basis for a calculation of a reference parameter or set of parameters which can be stored instead of or in conjunction with the point cloud data for a reference object (human) for comparison with a parameter or set of parameters derived or calculated from a point cloud for radar detections from an object (human).

When a cluster of measurement points are received from an object in the environment, a location of a particular part/point on the object or a portion of the object, e.g. its centre, may be determined by the CPU 202 from the cluster of measurement point positions having regard to the intensity or magnitude of the reflections (e.g. a centre location comprising an average of the locations of the reflections weighted by their intensity or magnitude). As illustrated in FIG. 3, the reference body has a point cloud from which its centre has been calculated and represented by the location 308, represented by the star shape. In this embodiment, the torso 304 of the body is separately identified from the body and the centre of that portion of the body is indicated. In alternative embodiments, the body can be treated as a whole or a centre can be determined for each of more than one body part e.g. the torso and the head, for separate comparisons with centres of corresponding portions of a scanned body.

In one or more embodiments, the object's centre or portion's centre is in some embodiments a weighted centre of the measurement points. The locations may be weighted according to an Radar Cross Section (RCS) estimate of each measurement point, where for each measurement point the RCS estimate may be calculated as a constant (which may be determined empirically for the reflected wave detector 206) multiplied by the signal to noise ratio for the measurement divided by R⁴, where R is the distance from the reflected wave detector 206 antenna configuration to the position corresponding to the measurement point. In other embodiments, the RCS may be calculated as a constant multiplied by the signal for the measurement divided by R⁴.

This may be the case, for example, if the noise is constant or may be treated as though it were constant. Regardless, the received radar reflections in the exemplary embodiments described herein may be considered as an intensity value, such as an absolute value of the amplitude of a received radar signal.

In any case, the weighted centre, WC, of the measurement points for an object may be calculated for each dimension as:

$$WC = \frac{1}{{\sum }_{n = 11}^{N} {W}_{n}} {\sum }_{n = 1}^{N} ( {W}_{n} {P}_{n} )$$

### Where:

N is the number of measurement points for the object;
Wₙ is the RCS estimate for the n^{th} measurement point; and
Pₙ is the location (e.g. its coordinate) for the n^{th} measurement point in that dimension.

### Detecting an Object

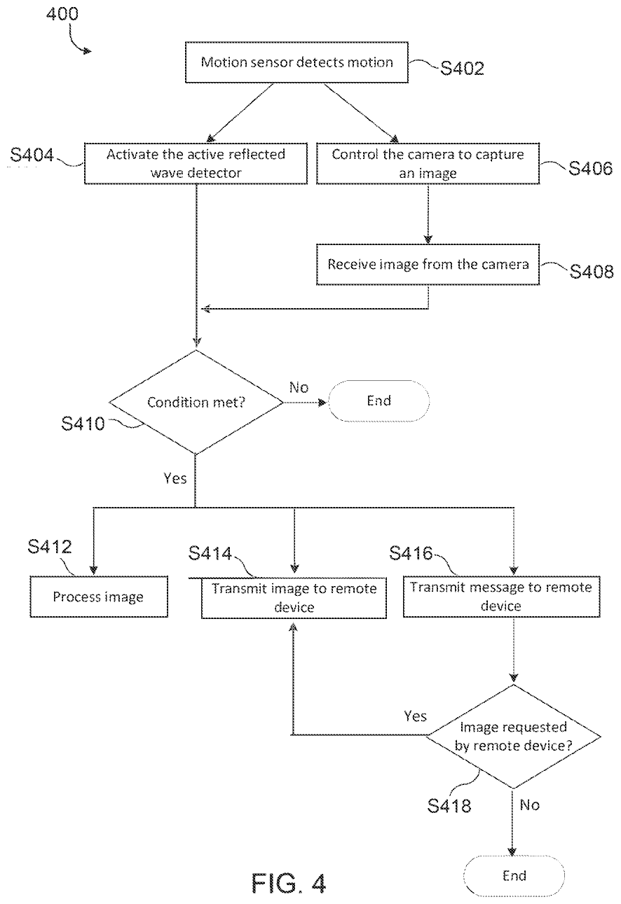

FIG. 4 illustrates an example process 400 performed by the CPU 202 for detecting an object in an environment according to a first embodiment of the present disclosure.

Prior to step S402 the active reflected wave detector 206 is in a deactivated state. In the deactivated state the active reflected wave detector 206 may be turned off. Alternatively, in the deactivated state the active reflected wave detector 206 may be turned on but in a low power consumption operating mode whereby the active reflected wave detector 206 is not operable to perform reflected wave measurements. By maintaining the active reflected wave detector 206 in a default state of being deactivated, power is advantageously conserved.

At step S402, in some embodiments the CPU 202 determines that the motion sensor 204 has detected motion in the environment based on receiving an output signal indicative of detected motion from the motion sensor 204.

At step S404, in response to the detected motion the CPU 202 activates the active reflected wave detector 206 so that it is in an activated state (e.g. a higher power consumption operating mode) and operates to measure wave reflections from the monitored space of the environment.

In other embodiments, the control hub 106 may receive the output signal from the motion sensor 204 and determine that the motion sensor 204 has detected motion in the environment based on the output signal being indicative of detected motion. In these embodiments, in response to the detected motion the control hub 106 may transmit a command to activate the active reflected wave detector 206. The control hub 106 transmits the command to a processor that controls the active reflected wave detector 206 (which may be the CPU 202 or another processor).

In these other embodiments, in the scenario whereby the housing 200 houses the active reflected wave detector 206 and the motion sensor 204, the control hub 106 transmits the command to the CPU 202. In the scenario whereby the housing 200 houses the active reflected wave detector 206 but does not house the motion sensor 204, the control hub 106 transmits the command to the CPU 202. In the scenario whereby the housing 200 houses the motion sensor 204 but does not house the active reflected wave detector 206, the control hub 106 may transmit the command to a processor (not shown in the Figures) that controls the active reflected wave detector 206. In the latter two scenarios, rather than the motion sensor 204 and active reflected wave detector 206 being within a common apparatus 102, they may be within respective apparatuses that may operate independently of each other.

In response to the detected motion, in some embodiments at step S406 the CPU 202 additionally controls the camera 208 to capture an image of the environment, and subsequently receives image data associated with a captured image from the camera 208.

In other embodiments, as noted above, the control hub 106 may receive the output signal from the motion sensor 204 and determine that the motion sensor 204 has detected motion in the environment based on the output signal being indicative of detected motion. In these embodiments, in response to the detected motion the control hub 106 may transmit a command to the camera 208 instructing the camera to capture an image of the environment. In these other embodiments, the CPU 202 may receive the image data associated with a captured image from the camera 208. Alternatively the image data may be transmitted from the camera 208 to the control hub 206 which then sends to image data to the CPU 202.

In these other embodiments, the control hub 106 may take into account one or more factors before transmitting the command to activate the active reflected wave detector 206 and the command to the camera 208 instructing the camera to capture an image of the environment. For example, the control hub 106 may be controlled to be in an armed mode or unarmed mode. Thus, in this example the control hub 106 may transmit the command to activate the active reflected wave detector 206 and the command to the camera 208 instructing the camera to capture an image of the environment if the control hub 106 is in an armed mode. However preferably the device 102 knows whether the control hub 106 (or itself) is in an armed mode or unarmed mode and only takes the necessary steps to activate the active reflected wave detector 206 and instruct the camera to capture an image of the environment in the event that the armed mode is active.

In some embodiments, prior to step S406 the camera 208 is in a deactivated state. In the deactivated state the camera 208 may be turned off. Alternatively, in the deactivated state the camera 208 may be turned on but in a low power consumption operating mode (e.g. a sleep mode) whereby the camera 208 is not operable to capture images of the environment. By maintaining the camera 208 in a default state of being deactivated, power is advantageously conserved. In these embodiments, step S406 comprises activating the camera 208 so that it is in an activated state and operable to capture images of the environment. In other words, in the activated state, the camera is powered up and is ready to capture one or more images. The powering up of the camera may be in relation to an image sensor and/or an image processor, for example. It is therefore in a higher power consumption operating mode. Being ready to capture one or more images may comprise having one or more of: a camera aperture setting and a shutter speed/exposure time selected to suit the current ambient conditions (e.g. based on a light intensity measured by a light sensor that is independent of the camera's image sensor). Being ready to capture one or more images may more particularly comprise having at least the camera aperture setting selected.

In the process 400, before the CPU 202 performs an action on the image data of the image, the process 400 proceeds to step S410 where the CPU 202 processes accrued measured wave reflection data to determine whether a predetermined condition is met.

In one example, the predetermined condition comprises that an object is detected in the environment. Various techniques may be used to determine whether an object is detected in the environment. In one possible implementation, the object detection at step S410 may be performed using a tracking module in the CPU 202 and the CPU 202 determines that an object is present in the environment because a cluster of detection measurements (also referred to as measurement points above) can be tracked by the tracking module.

The tracking module can use any known tracking algorithm. For example, the active reflected wave detector 206 may generate a plurality of detection measurements (e.g. up to 100 measurements, or in other embodiments hundreds of measurements) for a given frame. Each measurement can be taken a defined time interval apart such as 0.5, 1, 2 or 5 seconds apart. Each detection measurement may include a plurality of parameters in response to a received reflective wave signal above a given threshold. The parameters for each measurement may for example include an x and y coordinate (and z coordinate for a 3D active reflected wave detector 206), a peak reflection value, and a Doppler value corresponding to the source of the received radar signal.

The data can then be processed using a clustering algorithm to group the measurements into one or more measurement clusters corresponding to a respective one or more targets. An association block of the tracking module may then associate a given cluster with a given previously measured target. A Kalman filter of the tracking module may then be used to estimate the next position of the target based on the corresponding cluster of measurements and a prediction by the Kalman filter of the next position based on the previous position and one or more other parameters associated with the target, e.g. the previous velocity. As an alternative to using a Kalman filter other tracking algorithms known by the person skilled in the art may be used.

The tracking module may output values of location, velocity and/or RCS for each target, and in some embodiments also outputs acceleration and a measure of a quality of the target measurement, the latter of which is essentially to act as a noise filter. The values of position (location) and velocity (and acceleration, if used) may be provided in 2 or 3 dimensions (e.g. cartesian or polar dimensions), depending on the embodiment.

The Kalman filter tracks a target object between frames and whether the Kalman filter's estimation of the objects' parameters converges to the object's actual parameters may depend on the kinematics of the object. For example, more static objects may have a better convergence. The performance of the Kalman filter may be assessed in real time using known methods to determine whether the tracking meets a predefined performance metric, this may be based on a covariance of the Kalman filter's estimation of the object's parameters. For example, satisfactory tracking performance may be defined as requiring at least that the covariance is below a threshold. Depending on the object's motion, the Kalman filter may or may not produce satisfactory performance within a predefined number of frames (e.g. 3-5 frames). The frames may be taken at a rate of 10 to 20 frames per second, for example.

In another example, the predetermined condition comprises that a human is detected in the environment. Any known method for detecting whether the object is human or not can be used. In particular, determining whether the detected object is human may not use a reference object that described above with reference to FIG. 3. In one example, this may be performed using the tracking module referred to above.

In some implementations, the RCS of the object may be used at step S410 to determine whether the detected object is human or not. In particular, from the reflected wave measurements an RCS of an object represented by a cluster of measurement points can be estimated by summing the RCS estimates of each of the measurement points in the cluster. This RCS estimate may be used to classify the target as a human target if the RCS is within a particular range potentially relevant to humans for the frequency of the signal emitted by the active reflected wave detector 206, as the RCS of a target is frequency dependent. Taking a 77 GHz radar signal as an example, from empirical measurements, the RCS (which is frequency dependent) of an average human may be taken to be in the order of 0.5 m², or more specifically in a range between 0.1 and 0.7 m², with the value in this range for a specific person depending on the person and their orientation with respect to the radar. The RCS of human in the 57-64 GHz spectrum is similar to the 77 GHz RCS—i.e. 0.1 and 0.7 m². If the RCS is outside that range it may be concluded that the object is inhuman.

Additionally or alternatively, the velocity information associated with the object may be used at step S410 to determine whether the detected object is human or not. For example, it may be concluded that no human is present if there is no detected object having a velocity within a predefined range and/or having certain dynamic qualities that are characteristic of a human.

The above examples are ways of determining that the object is human, which may reflect that the object is likely to be human, or fails a test which would determine that the object is inhuman thereby implying that the object is potentially human. Thus, it will be appreciated by persons skilled in the art that there may be a significant level of error associated with the determination that the object is human.

Optionally, the CPU 202 may process the accrued measured wave reflection data to perform a determination as to whether the person is in a fall position (i.e. a position that is consistent with them haven fallen) or a non-fall position (indicative that they are, at least temporarily, in a safe state). In some embodiments of the present disclosure the determination that the person is in a fall position or has fallen is used as an indicator that the person may be in need of help, e.g. an intruder has fallen whilst attempting to access a premises. In these embodiments the CPU 202 may generate a fall alert and transmit the fall alert to the control hub 106 for subsequent transmission to one or more of the remote monitoring station 110, the server 112 and the remote personal computing device 114. Additionally or alternatively the CPU 202 may transmit the alert message directly to one or more of the remote monitoring station 110, the server 112 and the remote personal computing device 114. It will be therefore be appreciated that the present invention may also have application beyond the field of security. For example, it may be used as a fall detector to monitor a person at risk of falling.

In another example, the predetermined condition comprises that an object is located in, or has moved towards, a predetermined area within the field of view of the active reflected wave detector 206. As discussed above, such location information may be provided by the tracking module referred to above, or by other means. The predetermined area within the field of view of the active reflected wave detector 206 may correspond to a region of interest defined by a virtual fence within the field of view of the active reflected wave detector 206. During installation of the device 102, the installer will switch the device to a calibration or configuration mode for the defining of the virtual fence. Exemplary methods for an installer to define such a virtual fence is described in International patent application number PCT/IL2020/050130, filed 4 Feb. 2020, the contents of which are incorporated herein by reference. However, other methods of defining a virtual fence may alternatively be employed. It will be appreciated that more than one virtual fence may be defined within the field of view of the active reflected wave detector 206.

If an object is located in the predetermined area within the field of view of the active reflected wave detector 206 this indicates a possible security threat, whereas if the object is outside of the predetermined area this indicates that even though an object is present their presence is not deemed a security threat, or at least not of a sufficient threat to perform an action related to camera image data.

It will be appreciated that at step S410, other predetermined conditions may be checked that are not described herein.

If, at step S410, the CPU 202 determines that the predetermined condition is met, the CPU 202 proceeds to take appropriate action examples of which are described below.

In response to determining at step S410 that the predetermined condition is met, the process 400 may proceed to step S412 where the image data representing the captured image is processed locally on the device 102 to verify that the predetermined condition is met. This image processing may be performed by the image processing module 212 on the CPU 202 (as shown in FIG. 2). Alternatively, the CPU 202 may supply to the image data to another local processor comprising the image processing module 212 to perform the image processing.

It can be seen that the power intensive image processing is only performed if both the motion sensor 204 has detected motion and the predetermined condition is met based on processing accrued measured wave reflection data from the active reflected wave detector 206

If the CPU 202 verifies from the local image processing that the predetermined condition is met, the CPU 202 may transmit an alert message to the control hub 106 for subsequent transmission to one or more of the remote monitoring station 110, the server 112 and the remote personal computing device 114. Additionally or alternatively, the CPU 202 may transmit the alert message directly to one or more of the remote monitoring station 110, the server 112 and the remote personal computing device 114.

Additionally or alternatively, if the CPU 202 verifies from the local image processing that the predetermined condition is met, the CPU 202 may transmit, via the communications interface 214, the image data representing the captured image to the control hub 106 for subsequent transmission to one or more of the remote monitoring station 110, the server 112 and the remote personal computing device 114. Additionally or alternatively, the CPU 202 may transmit, via the communications interface 214, the image data representing the captured image directly to one or more of the remote monitoring station 110, the server 112 and the remote personal computing device 114.

If the CPU 202 determines from the local image processing that the predetermined condition is not met, the image data representing the captured image may be stored in memory 210 or discarded. The CPU 202 then awaits further detected motion in the environment in which case the process 400 is repeated starting at step S402.

In response to determining at step S410 that the predetermined condition is met, the process 400 may proceed to step S414 where the CPU 202 transmits, via the communications interface 214, the image data representing the captured image to the control hub 106 for subsequent transmission to one or more of the remote monitoring station 110, the server 112 and the remote personal computing device 114. Additionally or alternatively the CPU 202 may transmit, via the communications interface 214, the image data representing the captured image directly to one or more of the remote monitoring station 110, the server 112 and the remote personal computing device 114.

The CPU 202 then awaits further detected motion in the environment in which case the process 400 is repeated starting at step S402.

The image processing described above to verify that the predetermined condition is met may be performed locally on the device 102, but in this example it is not performed locally on the device 102 and is instead performed on one of the remote monitoring station 110, the server 112 and the remote personal computing device 114. This advantageously conserves power on the device 102.

Whilst steps S412 and S414 have been described above with reference to the image processing (whether performed locally or remote from the device) being performed to verify that the predetermined condition is met. Additionally or alternatively, this image processing may be performed to check whether another condition is met. For example, if the accrued measured wave reflection data is processed at step S410 to determine that an object is detected in the environment, the image data representing the captured image may be processed to determine whether the object is human (rather than verifying that an object has been detected), or to determine whether the object is not an inhuman animal (e.g. not a pet, such as a dog or a cat). In another example, the image data representing the captured image may be processed using facial recognition techniques wherein the other condition is that the person is a known criminal, black-listed person or not a white-listed person.

In response to determining at step S410 that the predetermined condition is met, the process 400 may proceed to step S416 where the CPU 202 transmits, via the communications interface 214, a message which indicates that the camera 208 has captured an image of the monitored environment. The CPU 202 may transmit the message to the control hub 106 for subsequent transmission to one or more of the remote monitoring station 110, the server 112 and the remote personal computing device 114. Additionally or alternatively, the CPU 202 may transmit the alert message directly to one or more of the remote monitoring station 110, the server 112 and the remote personal computing device 114.

In this example, if in reply the CPU 202 receives a request at step S418 from a remote device (e.g. one of the control hub 106, the remote monitoring station 110, the server 112 and the remote personal computing device 114) for the image data representing the captured image, the process proceeds to step S414 where CPU 202 transmits the image data representing the captured image to the remote device.

The transmission at step S416 of the message which indicates that the camera 208 has captured an image of the monitored environment acts as an alert that the camera has been triggered. The uploading of image data to a remote device is a relatively power intensive task, and in this example the CPU 202 only uploads image data to the remote device if commanded to do so from the remote device.

If the remote device does not request the image data representing the captured image, the image data representing the captured image may, in some embodiments, be deleted. The CPU 202 then awaits further detected motion in the environment in which case the process 400 is repeated starting at step S402.

Referring back to step S410, if the CPU 202 determines that the predetermined condition is not met, the image data representing the captured image may, in some embodiments be deleted. Power is conserved because further actions such as those described above in relation to steps S412. S414, and S416 are not performed. The CPU 202 awaits further detected motion in the environment in which case the process 400 is repeated starting at step S402.

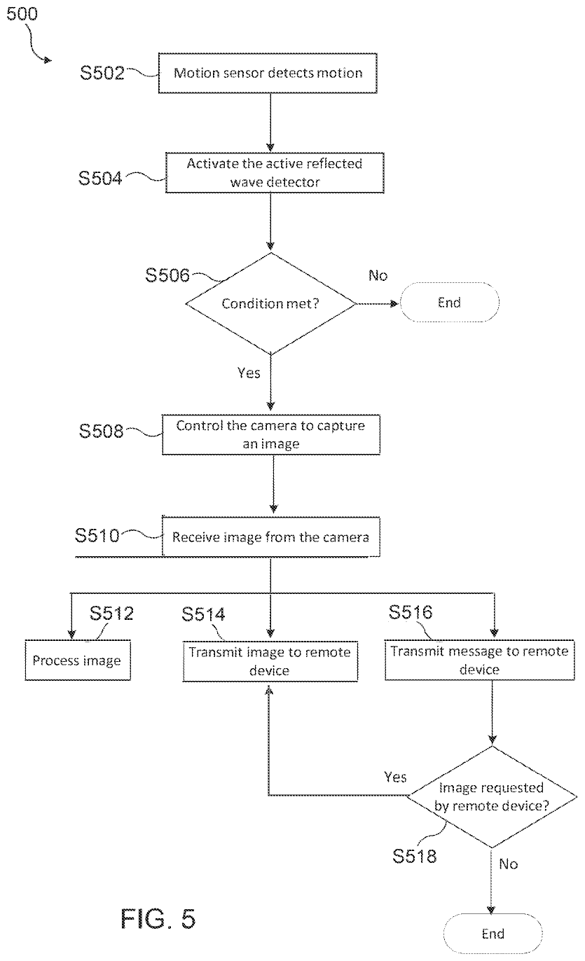

FIG. 5 illustrates an example process 500 performed by the CPU 202 for detecting an object in an environment according to another embodiment of the present disclosure.

Prior to step S502 the active reflected wave detector 206 is in a deactivated state. In the deactivated state the active reflected wave detector 206 may be turned off. Alternatively, in the deactivated state the active reflected wave detector 206 may be turned on but in a low power consumption operating mode whereby the active reflected wave detector 206 is not operable to perform reflected wave measurements. By maintaining the active reflected wave detector 206 in a default state of being deactivated, power is advantageously conserved.

At step S502, the CPU 202 determines that the motion sensor 204 has detected motion in the environment based on receiving an output signal indicative of detected motion from the motion sensor 204. Step S502 corresponds to step S402 described above with reference to process 400.

At step S504, in response to the detected motion the CPU 202 activates the active reflected wave detector 206 so that it is in an activated state (e.g. a higher power consumption operating mode) and operates to measure wave reflections from the monitored space of the environment. Step S504 corresponds to step S404 described above with reference to process 400.

The variants of how step S402 and S404 may be implemented which involve the control hub 106 that are described above also apply to steps S502 and S504. The control hub 106 is in some embodiments located at the premises, but in other embodiments the control hub 106 described herein may be located remote from the premises or its functions may be integrated into a server (which may be a distributed server). Such a server may also serve other premises.

In the process 500, before the CPU 202 controls the camera 208 to capture an image, the process 500 proceeds to step S506 where the CPU 202 processes accrued measured wave reflection data to determine whether a predetermined condition is met.

Step S506 may correspond to step S410. Examples of how step S410 (and thus step S506) may be implemented have been described above and are therefore not repeated. However, in other embodiments, the predetermined condition may be that it is determined that the person is in a fall position or has fallen.

If, at step S506, the CPU 202 determines that the predetermined condition is met, the CPU 202 determines that an intruder is present in the monitored environment and the process 500 proceeds to step S508 where the CPU 202 controls the camera 208 to capture an image of the environment. Step S508 may correspond to (e.g. involve the same actions as) step S406 of FIG. 4.

Whilst step S508 has been described above with reference to the CPU 202 controlling the camera 208 to capture an image of the environment, in other embodiments the CPU 202 transmits an indication that the predetermined condition is met to the control hub 106.

In these other embodiments, in response to receiving this indication the control hub 106 determines whether an image is to be captured by the camera 208. If the control hub 106 determines that an image is to be captured by the camera 208, the control hub 106 transmits a command to capture an image of the environment to a processor that controls the camera 208 (the processor that controls the camera 208 may be the CPU 202 or another processor). The CPU 202 may then receive the image data associated with a captured image from the camera 208. Alternatively the image data may be transmitted from the camera 208 to the control hub 206 which then sends the image data to the CPU 202.

In these other embodiments, in the scenario whereby the housing 200 houses the active reflected wave detector 206 and the camera 208, the control hub 106 transmits the command to the CPU 202. In the scenario whereby the housing 200 houses the camera 208 but does not house the active reflected wave detector 206, the control hub 106 transmits the command to the CPU 202. In the scenario whereby the housing 200 houses the active reflected wave detector 206 but does not house the camera 208, the control hub 106 may transmit the command to a processor (not shown in the Figures) that controls the camera 208. In the latter two scenarios, rather than the camera 208 and active reflected wave detector 206 being within a common apparatus 102, they may be within respective apparatuses that may operate independently of each other.

In some embodiments, prior to step S502 the camera 208 is in a deactivated state. In the deactivated state the camera 208 may be turned off. Alternatively, in the deactivated state the camera 208 may be turned on but in a low power consumption operating mode whereby the camera 208 is not operable to capture images of the environment. By maintaining the camera 208 in a default state of being deactivated, power is advantageously conserved.

In some embodiments, in response to detecting motion at step S502, the CPU 202 may activate the camera 208 so that it is in an activated state and operable to capture images of the environment, despite the capturing of the images only occurring later, conditional on the predetermined condition being met.

In other embodiments, the camera 208 is in the deactivated state until step 508. In these embodiments, step S508 comprises activating the camera 208 so that it is in an activated state and operable to capture images of the environment.

Following step S508, the CPU 202 receives image data associated with a captured image from the camera 208.

The CPU 202 then performs an action on the image data associated with the captured image.

The process 500 may proceed to step S512. Step S512 corresponds to step S412 described above with reference to process 400.

The process 500 may proceed to step S514. Step S514 corresponds to step S414 described above with reference to process 400.

The process 500 may proceed to step S516. Step S516 corresponds to step S416 described above with reference to process 400.

Referring back to step S506, if the CPU 202 determines that the predetermined condition is not met, the CPU 202 does not control the camera 208 to capture an image. Instead, the CPU 202 awaits further detected motion in the environment in which case the process 500 is repeated starting at step S502. This advantageously conserves power.

For each of the examples described herein, it is preferable that whenever awaiting a further detected motion the camera 208 is again in the lower power mode. The returning of the camera 208 to the low power mode may occur as soon as the image data is captured at step S406 or 508.

In some implementations of the process 500, if the CPU 202 receives a request at step S518 from a remote device for the image data representing the captured image, the process proceeds to step S514 where CPU 202 transmits the image data representing the captured image to the remote device. For example, step S518 may correspond to step S418 described above with reference to process 400.

### Monitoring Regions

The CPU 202 is configured to process measured wave reflection data to perform steps S410 and S506. This measured wave reflection data that is output by the active reflected wave detector 206 is in response to the active reflected wave detector 206 measuring wave reflections from a “condition monitoring region” in the environment. The condition monitoring region is so named because the device 102 is configured to take one or more defined actions conditional on one or more defined events occurring therein. For example device 102 may require at least that an object of interest be identified inside the condition monitoring region as a precondition for performing a certain action in response, e.g. triggering an alarm and/or issuing a notification to a remote device. e.g. a server.

This condition monitoring region may be the “radar monitoring region” described above. That is, in these implementations the measured wave reflection data used by the CPU 202 to perform steps S410 and S506 is output by the active reflected wave detector 206 in response to the active reflected wave detector 206 measuring wave reflections from the maximum region that the active reflected wave detector is configured to monitor of the active reflected wave detector 206.

Alternatively, the condition monitoring region may be a user defined “radar region of interest” described above that is within the radar monitoring region. In these examples, the CPU 202 may also receive measured wave reflection data that is output by the active reflected wave detector 206 in response to the active reflected wave detector 206 measuring wave reflections from regions of the environment outside the condition monitoring region, but the CPU 202 will determine at steps S410 and S506 that the condition tested in those steps is not met. As noted above, the radar monitoring region is considered the region that is observable by the active reflected wave detector 206 (e.g. the radar). The radar monitoring region may be fixed at the time of its manufacture or in some embodiments may be subsequently changed via configuration settings in software. However, regardless, a user may define one or more virtual fences defining the boundaries of a respective one or more radar regions of interest within the radar monitoring region.

In some embodiments, the motion detection monitoring region described above includes at least part of the condition monitoring region and extends beyond the condition monitoring region in at least one direction. In some implementations, the motion detection monitoring region extends beyond the condition monitoring region by at least 1 metre in the at least one direction, preferably by at least 2 metres in the at least one direction.

This advantageously means that if a person enters the condition monitoring region, the motion sensor 204 will have already been triggered thereby resulting in the activation of the active reflected wave detector 206 to measure wave reflections from the condition monitoring region.

Were the motion detection monitoring region entirely within and smaller than the condition monitoring region then it would be possible for a person to enter the condition monitoring region undetected since the active reflected wave detector 206 will not be operational at that time (since the active reflected wave detector 206 requires that the motion of the object first be detected by the motion sensor 204 before the active reflected wave detector 206 is activated).

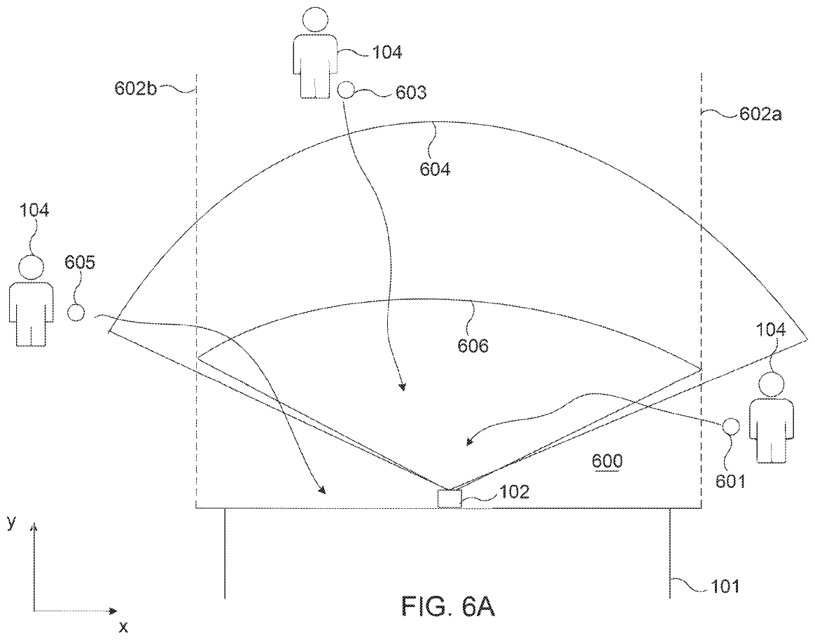

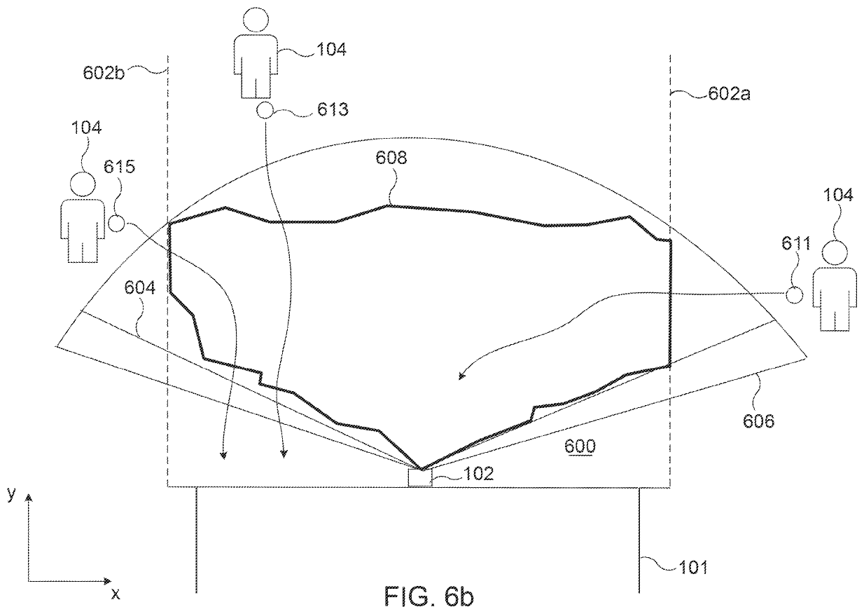

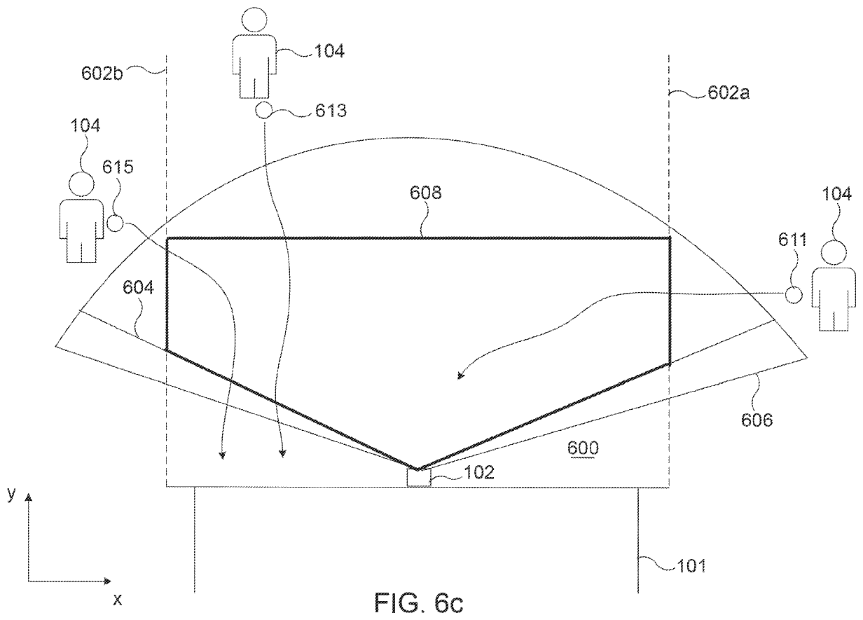

FIG. 6a illustrates a top view of a portion of a building 101 onto which the device 102 has been mounted, and the building's adjacent outdoor surroundings.

The device 102 comprises a motion sensor 204 having a motion detection monitoring region 604 which is directed down the length of a yard 600 of the property which is enclosed by wire fences 602. The device 102 also comprises an active reflected wave detector 206 having a radar monitoring region 606.

In this example a user has not defined a virtual fence (i.e. the bounds of a radar region of interest) that is within the radar monitoring region 606. That is, in this example, the condition monitoring region is the radar monitoring region 606.

In implementations the motion detection monitoring region 604 may extend beyond the condition monitoring region in at least one lateral direction (which in FIG. 6a is shown by the x axis) with respect to the axis in which the radar is pointed.

In the example of FIG. 6a the motion detection monitoring region 604 extends in the positive x-direction beyond the radar monitoring region 606. Thus if an intruder 104 approaches the property in a horizontal direction over fence 602a, from position 601 for example, the motion sensor 204 would detect the motion of the intruder 104 and activate the active reflected wave detector 206, so they will not be able to progress into the part of the property covered by the condition monitoring region without being detected by the active reflected wave detector 206. In the example of FIG. 6a the motion detection monitoring region 604 also extends in the negative x-direction beyond the radar monitoring region 606. Thus if an intruder 104 approaches the property in a horizontal direction over fence 602b, from position 605 for example, the motion sensor 204 would detect the motion of the intruder 104 and activate the active reflected wave detector 206, so they will not be able to progress into the part of the property covered by the condition monitoring region without being detected by the active reflected wave detector 206.

Whilst FIG. 6a shows the motion detection monitoring region 604 extending in the positive x-direction beyond the radar monitoring region 606 and also extending in the negative x-direction beyond the radar monitoring region 606, it will be appreciated that this is merely an example.

As shown in FIG. 6a, a depth (in the positive y-direction) of the motion detection monitoring region 604 may extend beyond a depth of the condition monitoring region. In the example of FIG. 6a the motion detection monitoring region 604 extends in the positive y-direction beyond the radar monitoring region 606. Thus if an intruder 104 approaches the rear of the property from position 603 up the yard towards the house 101, the motion sensor 204 would detect the motion of the intruder 104 and activate the active reflected wave detector 206.

FIG. 6b illustrates an example whereby a user has defined a virtual fence bounding a radar region of interest 608 that is within the radar monitoring region 606. That is, in this example, the condition monitoring region corresponds to the radar region of interest 608.

The radar region of interest 608 may be defined in a number of different ways.

In the example shown in FIG. 6b the user has defined the radar region of interest 608 using a graphical user interface displayed on a display of computing device (such as smartphone or tablet) to define the radar region of interest 608. For example, the user may trace the shape of the radar region of interest 608 using a touchscreen of the computing device. The computing device may then transmit data defining the radar region of interest 608 to the device 102, which is received by the CPU 202 via the communications interface 214.

In the example shown in FIG. 6b, the user has defined the radar region of interest 608 in the x-direction such that it meets the horizontal boundaries of the yard 600 defined by wire fences 602 and extends in the y-direction down the length of the yard.

The motion detection monitoring region 604 may extend beyond the condition monitoring region in at least one lateral direction, which in FIG. 6b is shown by the x axis. In the example of FIG. 6b the motion detection monitoring region 604 extends in the positive x-direction beyond the radar region of interest 608. Thus if an intruder 104 approaches the property in a horizontal direction over fence 602a, from position 611 for example, the motion sensor 204 would detect the motion of the intruder 104 and activate the active reflected wave detector 206, so they will not be able to progress into the part of the property covered by the condition monitoring region without being detected as being in that region by the active reflected wave detector 206. In the example of FIG. 6b the motion detection monitoring region 604 also extends in the negative x-direction beyond the radar region of interest 608. Thus if an intruder 104 approaches the property in a horizontal direction over fence 602b, from position 615 for example, the motion sensor 204 would detect the motion of the intruder 104 and activate the active reflected wave detector 206, so they will not be able to progress into the part of the property covered by the condition monitoring region without being as being in that region detected by the active reflected wave detector 206.

Whilst FIG. 6b shows the motion detection monitoring region 604 extending in the positive x-direction beyond the radar region of interest 608 and also extending in the negative x-direction beyond the radar region of interest 608, it will be appreciated that this is merely an example.

As shown in FIG. 6b, a depth (in the positive y-direction) of the motion detection monitoring region 604 may extend beyond a depth of the condition monitoring region. In the example of FIG. 6b the motion detection monitoring region 604 extends in the positive y-direction beyond the radar region of interest 608. Thus if an intruder 104 approaches the rear of the property from position 613 up the yard towards the house 101, the motion sensor 204 would detect the motion of the intruder 104 and activate the active reflected wave detector 206.

FIG. 6c illustrates another example whereby a user has defined a virtual fence (i.e. a radar region of interest 608) that is within the radar monitoring region 606. That is, in this example, the condition monitoring region corresponds to the radar region of interest 608.

In order to define the radar region of interest 608 as shown in the example of FIG. 6c, the user may switch the active reflected wave detector 206 into a calibration or configuration mode for defining the radar region of interest 608. The user then walks around the environment (e.g. the yard) to define the radar region of interest 608. The tracking module of the device 102 tracks the path of the person as the person walks based on the output of the active reflected wave detector 206 and creates a trajectory in the 2D plane. Optionally the person may carry a radar reflector. e.g. a metal corner reflector, which in some embodiments is held or worn with its measurement centre at a known height above the surface (e.g. known to within 20% or in more precise embodiments to within 10%). The corner reflector may advantageously be sized to be held within a person's hand. The use of a radar reflector can increase the estimated RCS of the object (the person in combination with the radar reflector) by increasing the signal to noise ratio of measurements from the object, which may assist more precise tracking of the object. Alternatively, the user may place reflectors at multiple locations in the yard to define the desired radar region of interest 608. Such reflectors may be mounted on poles or other structures. In these implementations, the CPU 202 is configured to process the wave reflection data to determine locations of the reflectors placed in the environment by a user to define the radar region of interest 608.

In an alternative method to define the radar region of interest 608 as shown in the example of FIG. 6c, the user may use a graphical user interface displayed on a display of computing device (such as smartphone or tablet) to define the radar region of interest 608. For example the user select the shape of the radar region of interest 608 shown in FIG. 6c from one or more predefined shapes for the radar region of interest 608 within a menu displayed by the graphical user interface. The shape of the shape of the radar region of interest 608 may be defined by curved lines and/or straight lines.

In some implementations, in at least one direction, the motion detection monitoring region 604 extends further from the active reflected wave detector 206 than the condition monitoring region extends from the active reflected wave detector.

In some implementations, the condition monitoring region is entirely enclosed by the motion detection monitoring region 604. This is illustrated in FIGS. 6a-c whereby the radar region of interest 608 is entirely enclosed by the motion detection monitoring region 604. It will be appreciated that in other implementations, the condition monitoring region may be only partially enclosed by the motion detection monitoring region 604.

Whilst FIGS. 6a-c show the device 102 being mounted to the house 101 such that the motion detection monitoring region 604 of the motion sensor 204, and the radar monitoring region 606 of the active reflected wave detector 206, are both directed down the length of the yard in a perpendicular manner, it will be appreciated that this is merely an example.

In other configurations the device may be mounted to one of the side fences 602 such that the lateral direction (with respect to the axis in which the radar is pointed) is the direction from which a person may approach the house from the rear. In yet other configurations, the device may be mounted in a corner of the yard 600 with it facing the rear of the yard at, for example, a 45 degree angle.

### Deactivating the Camera

In existing devices using a PIR sensor and a camera, a time-out may be used on PIR detections to determine when to switch a camera to a low power state. If no motion detections have occurred for a predetermined time period, the camera is controlled to go into a low power mode.

The assumption is that the lack of motion detections is indicative of the person having left the PIR monitoring region. The inventors have identified that this is not necessarily the case though: the person might just have stopped moving for a sufficiently long time, or may be moving too slowly to be detected by the motion detector. The camera may be configured to stay on for a significant amount of time after the last detected motion to minimize the chance of turning off while the person is still present. However, this wastes substantial energy if the person had in fact left the region a long time earlier. In any case, the camera might turn off/go to sleep prematurely, as the person may still be present.

In the process 400 described above with reference to FIG. 4, and the process 500 described above with reference to FIG. 5, once the CPU 202 performs an action on the image data of the image, the CPU 202 may be configured to process measured wave reflection data that is output by the active reflected wave detector 206 in response to the active reflected wave detector 206 measuring wave reflections from a “camera control monitoring region” in the environment. The CPU 202 is configured to control the camera 208, in particular its operating mode, based on measured wave reflection data associated with wave reflections from the camera control monitoring region in the environment.

In these embodiments, the CPU 202 is configured to process measured wave reflection data to detect that a predefined condition comprising that the object has left the camera control monitoring region has been met, and in response cause the camera 208 to switch from its higher power consumption operating mode (in which it is in an activated state and operable to capture images of the environment) to a lower power consuming mode.

Thus, in response to detecting that the object has left the camera control monitoring region, the CPU 202 may cause the camera 208 to switch off or to remain turned on but in a low power consumption operating mode (e.g. a sleep mode) whereby the camera 208 is not operable to capture images of the environment e.g. because the imaging sensor and/or image processor of the camera 208 is unpowered or insufficiently powered.

The camera control monitoring region may correspond to the condition monitoring region referred to above. In particular, in some embodiments the camera control monitoring region is the same as the condition monitoring region. In other embodiments the camera control monitoring region is not the same as the condition monitoring region but there is at least a close correlation, for example they may have the same shape but one extends beyond the other by a predetermined distance (e.g. by the 1 to 2 meters or by 10% of its span, whichever is less) in all directions.

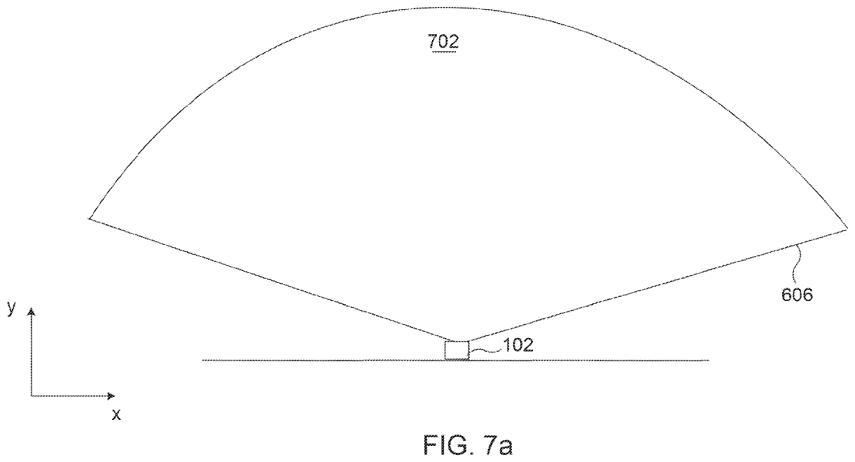

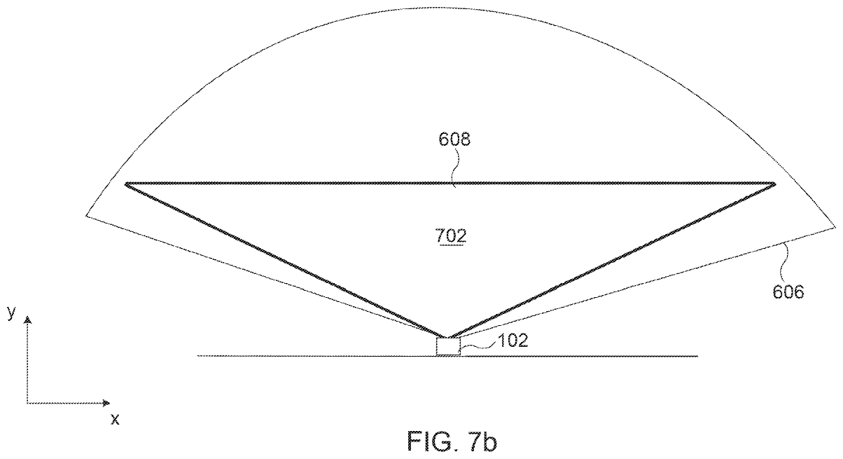

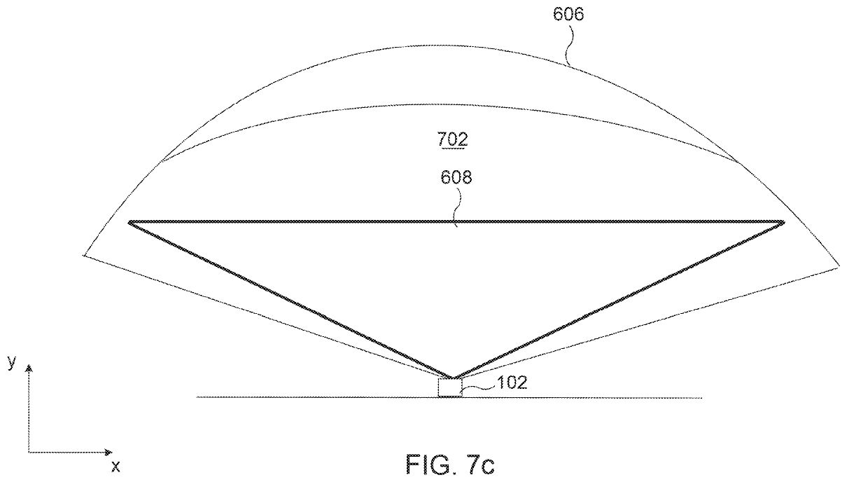

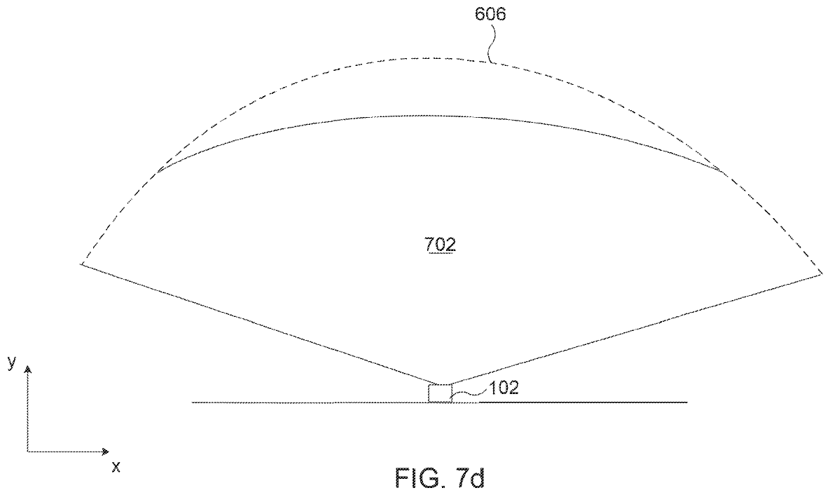

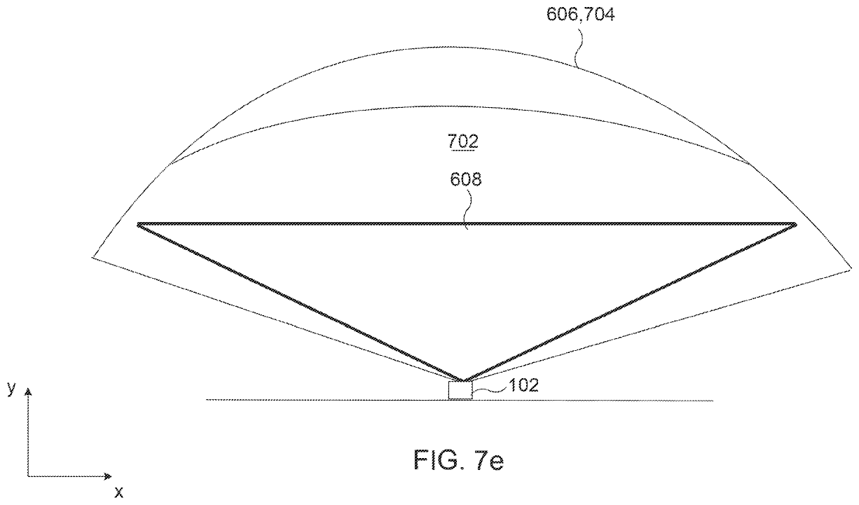

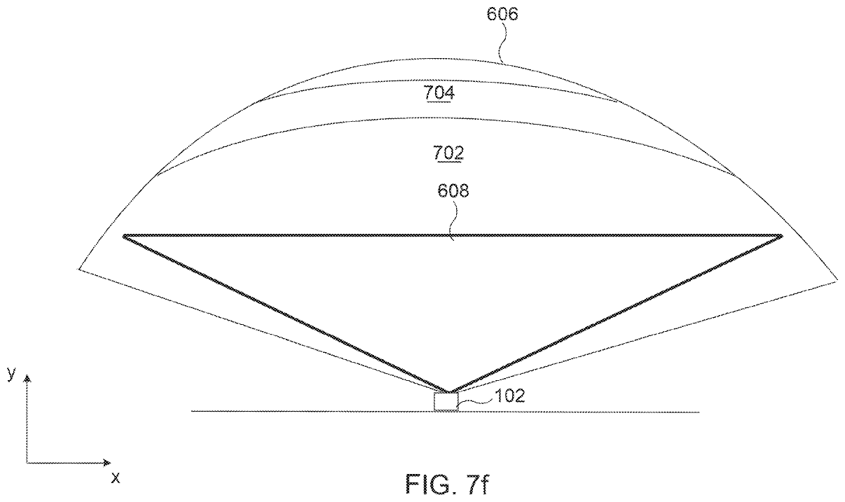

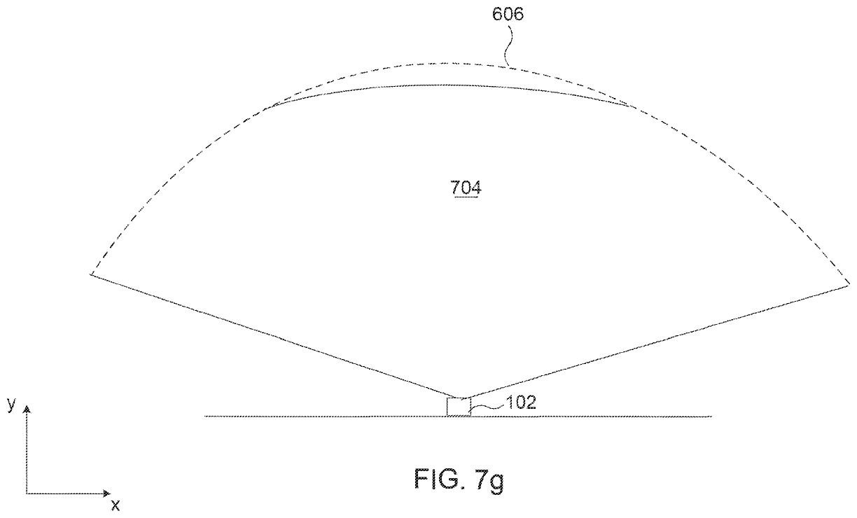

As noted above, in some implementations, the condition monitoring region is the “radar monitoring region” described above. That is, the measured wave reflection data used by the CPU 202 to control the camera 208 is output by the active reflected wave detector 206 in response to the active reflected wave detector 206 measuring wave reflections from the maximum region that the active reflected wave detector is configured to monitor) of the active reflected wave detector 206. This example is illustrated in FIG. 7a which shows the camera control monitoring region 702 being the same as the radar monitoring region 606. In this example, the camera 208 is kept in an activated state (the camera is powered up and is ready to capture one or more images). As long as an object can be tracked by the CPU 202 based on the output of the active reflected wave detector 206. The CPU 202 controls the camera 208 to be in a deactivated state in response to an object leaving the radar monitoring region 606.

Alternatively, the camera control monitoring region may be a user defined “radar region of interest” described above that is within the radar monitoring region. An example is illustrated in FIG. 7b which shows the camera control monitoring region being the same as a radar region of interest 608 within the radar monitoring region 606. In this example, power can be advantageously conserved by the camera 208 not being triggered to capture images in response to objects being present outside of the radar region of interest 608. The CPU 202 controls the camera 208 to be in a deactivated state (lower power consuming mode) in response to an object leaving the radar region of interest 608. Thus, power is not incurred to capture images when an object is positioned at a particular location in the environment that does not represent an immediate security concern.

In other implementations a camera control monitoring region that is larger than the condition monitoring region is used to identify when to control the camera 208 to operate in the lower power consuming mode.

For example in some implementations, the camera control monitoring region is a user defined “radar region of interest” (i.e. as may be defined by a virtual fence) that extends beyond the condition monitoring region in at least one direction.

FIG. 7c shows an example relationship between the radar monitoring region 606, the condition monitoring region 608, and camera control monitoring region 702. For clarity, FIG. 7d illustrates the example of FIG. 7c without the condition monitoring region (i.e. the radar region of interest 608) being shown.

As shown in FIGS. 7c and 7d, the camera control monitoring region 702 may extend beyond the condition monitoring region 608 in at least one lateral direction, which in FIGS. 7c and 7d is shown by the x axis. The camera control monitoring region 702 may extend beyond the condition monitoring region 608 in the at least one lateral direction by a distance of 4 metres or less, 3 metres or less, 2 metres or less, or 1 metre or less. In the example of FIGS. 7c and 7d, the camera control monitoring region 702 extends in the positive x-direction beyond the condition monitoring region 608 and also the negative x-direction beyond the condition monitoring region 608.

As shown in FIGS. 7c and 7d, a depth (in the positive y-direction) of the camera control monitoring region 702 may extend beyond a depth of the condition monitoring region 608. The camera control monitoring region 702 may extend beyond a depth of the condition monitoring region 608 by a distance of 4 metres or less, 3 metres or less, 2 metres or less, or 1 metre or less.

In this example, the camera 208 is kept in an activated state (the camera is powered up and is ready to capture one or more images) despite the object being just outside of the condition monitoring region 608. Thus, should the object re-enter the condition monitoring region 608, the camera will already be in activated state and ready to capture one or more images of the object. This avoids the need for the CPU 202 to deactivate and then reactivate the camera 208 in response to the object leaving and then re-entering the condition monitoring region 608.

As shown in FIG. 7c, the camera control monitoring region 702 may encompass the condition monitoring region 608.

In some implementations, the camera control monitoring region corresponds to the motion detection monitoring region referred to above. In particular, the camera control monitoring region may be the same as the motion detection monitoring region. In other embodiments the camera control monitoring region is not the same as the motion detection monitoring region but there is at least a close correlation, for example they may have the same shape but one extends beyond the other by a predetermined distance (e.g. by the 1 to 2 meters or by 10% of its span, whichever is less) in all directions.

In other implementations, the camera control monitoring region extends beyond the motion detection monitoring region in at least one direction. In this way the motion sensor 204 won't be triggered once the person leaves the camera control monitoring region. Once the person leaves the camera control monitoring region, the CPU 202 may return to utilizing measured wave reflection data associated with wave reflections from the smaller condition monitoring region.

The predefined condition may comprise that the object has stayed outside of the camera control monitoring region for a predetermined amount of time. Thus if the person leaves the camera control monitoring region and then shortly re-enters the camera control monitoring region (within a time period less than the predetermined amount of time) the CPU 202 will not cause the camera 208 to switch from its higher power consumption operating mode to a lower power consuming mode (the CPU will operate as though the person never left the camera control monitoring region).

The predefined condition may additionally comprise that the object has left a larger camera control monitoring region 704 that extends beyond the camera control monitoring region referred to above in at least one direction. In some implementations, the larger camera control monitoring region 704 is the “radar monitoring region” described above Alternatively, the larger camera control monitoring region 704 may be a user defined “radar region of interest” described above that is within the radar monitoring region. This larger camera control monitoring region may act a hard boundary whereby the CPU 202, in response to detecting that the object is no longer present in the larger camera control monitoring region, immediately causes the camera 208 to switch from its higher power consumption operating mode to a lower power consuming mode. Thus, the camera 208 is kept in an activated state (the camera is powered up and is ready to capture one or more images) even if the object has left the camera control monitoring region 702. Even if the object has not stayed outside of the camera control monitoring region 702 for a sufficient amount of time to cause deactivation of the camera, if the object leaves the larger camera control monitoring region 704, the CPU 202 controls the camera 208 to be in a deactivated state (lower power consuming mode). In these examples, power can be advantageously conserved by the camera 208 (and/or the active reflected wave detector 206) switching to a lower power consuming mode when the object has moved a significant distance away from the condition monitoring region 608 that means that they are unlikely to return imminently such that monitoring of the object (e.g. by the camera 208 and/or the active reflected wave detector 206) is no longer needed.

It will be appreciated that in these implementations the camera control monitoring region cannot be the radar monitoring region given that the larger camera control monitoring region extends beyond the camera control monitoring region in at least one direction.

The larger camera control monitoring region 704 may extend beyond the camera control monitoring region 702 referred to above in at least one lateral direction. Additionally or alternatively, a depth (in the positive y-direction) of the larger camera control monitoring region 704 may extend beyond a depth of the camera control monitoring region 702.

FIG. 7e illustrates an example whereby the larger camera control monitoring region 704 is the radar monitoring region 606 and a depth (in the positive y-direction) of the larger camera control monitoring region 704 extends beyond a depth of the camera control monitoring region 702. In this example, power can be advantageously conserved by the camera 208 (and/or the active reflected wave detector 206) switching to a lower power consuming mode when the object has moved a significant distance away from the condition monitoring region 608 by travelling outside of the radar monitoring region 606 such that the object can be no longer detected by the active reflected wave detector 206.

FIGS. 7f and 7g illustrates an example whereby a depth (in the positive y-direction) of the larger camera control monitoring region 704 extends beyond a depth of the camera control monitoring region 702 and the larger camera control monitoring region 704 is within the radar monitoring region 606. That is, a depth (in the positive y-direction) of the radar monitoring region 606 extends beyond a depth of the larger camera control monitoring region 704. For clarity. FIG. 7g illustrates the example of FIG. 7f without the condition monitoring region 608 being shown. In this example, further power savings can be achieved by way of earlier deactivation of the camera 208 compared to the examples of FIG. 7e. In particular, the CPU 202 controls the camera 208 to be in a deactivated state in response to an object that is still present in the radar monitoring region 606 but has moved a significant distance away from the condition monitoring region 608 that means that they are unlikely to return imminently such that monitoring of the object (e.g. by the camera 208 and/or the active reflected wave detector 206) is no longer needed.

The CPU 202 may cause the camera 208 to switch from its higher power consumption operating mode to a lower power consuming mode by transmitting a control signal to the camera 208. Alternatively, the CPU 202 may cause the camera 208 to switch from its higher power consumption operating mode to a lower power consuming mode by transmitting a control signal to the control hub 106 which then transmits a command to the camera 208 to cause it to switch from its higher power consumption operating mode to a lower power consuming mode.

Whilst the above methods have been described with reference to triggering the CPU 202 to cause the camera 208 to switch from its higher power consumption operating mode to a lower power consuming mode in response to the predefined condition being met, the CPU 202 may additionally or alternatively cause the active reflected wave detector 206 to switch from its higher power consumption operating mode to a lower power consuming mode in response to the predefined condition being met.

The CPU 202 may cause the active reflected wave detector 206 to switch from its higher power consumption operating mode to a lower power consuming mode by transmitting a control signal to the active reflected wave detector 206. Alternatively, the CPU 202 may cause the active reflected wave detector 206 to switch from its higher power consumption operating mode to a lower power consuming mode by transmitting a control signal to the control hub 106 which then transmits a command to the active reflected wave detector 206 to cause it to switch from its higher power consumption operating mode to a lower power consuming mode.

Whilst the deactivation of the camera 208 (and/or the active reflected wave detector 206) has been described above with reference to the process 400 of FIG. 4 and the process 500 of FIG. 5, the embodiments relating to deactivation of the camera 208 (and/or the active reflected wave detector 206) are not limited to being performed in conjunction with such processes. For example, whilst step S402 and step S502 are described with reference to the CPU 202 determining that the motion sensor 204 has detected motion in the environment, the methods described above relation to the deactivation of the camera 208 (and/or the active reflected wave detector 206) can be applied more generally in response to an activity in the environment being detected.

For example, at steps S402 and S502 the CPU 202 may, instead of detecting motion, detect that a sound level has exceeded a threshold sound level based on receiving an audio signal output from a microphone that is coupled to the CPU 202. The microphone may be housed within the housing 200 of the device 102. Alternatively, the microphone may be external to the device 102 and be coupled to the CPU 202 by way of a wired or wireless connection. In another example, at steps S402 and S502 the CPU 202 may detect that a vibration level has exceeded a vibration sound level based on receiving an output signal from one or vibration sensors that are coupled to the CPU 202. The vibration sensors may be external to the device 102 and positioned with the environment and be coupled to the CPU 202 by way of a wired or wireless connection. It will be apparent to persons skilled in the art that other sensors may additionally or alternatively be used for the activity detection.

Thus embodiments relating to the deactivation of the camera 208 are not limited to the use of a motion sensor 204.

### Determining Limits for a Virtual Fence

As noted above, a user is also able to define a virtual fence that corresponds to a radar region of interest within the radar monitoring region.

Since the radar region of interest may be set at installation depending on the environment in which it is to operate, there is a risk that after installation the radar region of interest may not correlate with the camera viewable region and/or motion detection monitoring region in a manner intended herein.

For example, in embodiments described above whereby the condition monitoring region corresponds to a radar region of interest that is within the radar monitoring region, it is intended that the motion detection monitoring region includes at least part of the radar region of interest and extends beyond the radar region of interest in at least one direction.

Alternatively and/or additionally it may be intended to have the camera viewable region at least encompassing the radar region of interest so that if an object is located anywhere in the radar region of interest an image of it can be captured by the camera.

We first refer to example implementations whereby the CPU 202 is coupled to the active reflected wave detector 206 (a first type of sensing device) and a second sensing device that is of a second type different to the first type. For example, the second sensing device may be the camera 208 or the motion sensor 204.

In these example implementations we describe an apparatus comprising: a first sensing device of a first type, the first type being an active reflected wave detector that is operable to measure wave reflections from said environment to detect said object; a second sensing device that is of a second type different to the first type; and a processor configured to; receive an input that defines a desired region of interest in respect of the first sensing device of the first type; and determine whether at least one part of the desired region extends beyond predefined limits, the predefined limits being correlated with viewable region limits associated with the second sensing device.

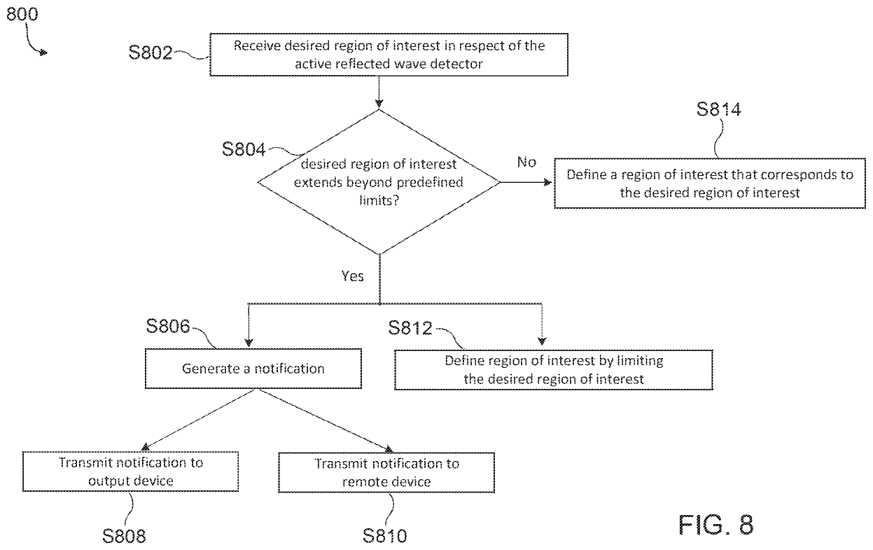

FIG. 8 illustrates an example process 800 performed by the CPU 202 for detecting that at least one part of a desired radar region of interest extends beyond predefined limits associated with the second sensing device.

At step S802, the CPU 202 receives a desired radar region of interest associated with the active reflected wave detector 206 that a user (e.g. an installer) wants the CPU 202 to monitor and take a certain action if an object is detected therein.

The CPU 202 may receive the desired radar region of interest in one of the various ways described above. e.g. by the CPU 202 tracking an object that moves along a boundary of the region based on the output of the active reflected wave detector 206, or by receiving the desired region of interest in response to it being traced or selected via a graphical user interface displayed on a remote computing device.

At step S804, the CPU 202 determines whether at least one part of the desired radar region extends beyond predefined limits, the predefined limits being correlated with viewable region limits associated with the second sensing device.

The viewable region limits of the camera 208 is the camera viewable region. The predefined limits of the camera 208 may be the same as the camera viewable region. In other embodiments the predefined limits of the camera 208 may have the same shape but be within the camera viewable region by a predetermined distance.

The viewable region limits of the motion sensor 204 is the motion detection monitoring region. The predefined limits of the motion sensor 204 may be the same as the motion detection monitoring region or may have the same shape but be within the motion detection monitoring region by a predetermined distance.

It will be appreciated that if a part of the desired radar region of interest extends beyond the camera viewable region, the camera 208 would be unable to capture an image of an object located in part of the radar region of interest.

Similarly, if a part of the desired radar region of interest extends beyond the motion detection monitoring region, the motion sensor 204 would not detect the motion of the object located in that part of the radar region of interest. Therefore the active reflected wave detector 206 would not be woken by the motion detector when an object moves in that part of the environment, despite the object being within the region of interest to the radar.

If the CPU 202 determines at step S804 that at least one part of the desired radar region extends beyond predefined limits, the CPU 202 performs an action.

Various actions can be taken in the event that at least one part of the desired region extends beyond the predefined limits.

In some examples, the CPU 202 generates a notification at step S806.

At step S808, the CPU 202 may transmit the notification to an audio output device (e.g. a speaker) for audible output by the audio output device. In this example, the notification is a sound notification. The audio output device may be housed within the housing 200 of the device 102. Alternatively, the audio output device may be external to the device 102 and coupled to the CPU 202 by way of a wired or wireless connection.

Additionally or alternatively, at step S808 the CPU 202 may transmit the notification to a display to provide a visual notification. The display may be housed within the housing 200 of the device 102. Alternatively, the display may be external to the device 102 and coupled to the CPU 202 by way of a wired or wireless connection.

Additionally or alternatively, at step S810 the CPU 202 may transmit the notification to a remote computing device (e.g. a smartphone, tablet, laptop, personal computer (PC) etc.) for audible and/or visual output by the remote computing device.

For example, if the user defines the virtual fence by walking along the boundary of the desired radar region of interest a speaker and/or display on the device 102 may output the notification. If the user defines the virtual fence by using a touch screen graphical user interface (or other input device) of a remote computing device a visual and/or audio notification may be presented by the remote computing device.

Such a notification enables the user to react and redefine the virtual fence appropriately.

In all of the above examples, the notification may indicate a location corresponding to the at least one part of the desired region of interest that extends beyond the predefined limits.

In other examples, at step S812 the CPU 202 defines a radar region of interest corresponding to the desired region of interest, but with the at least one part being at or within the predefined limits (e.g. by a predetermined distance). In other words, the CPU 202 automatically limits the desired region of interest as needed when defining the radar region of interest.

Referring back to step S804, if the CPU 202 determines that at least one part of the desired radar region does not extend beyond the predefined limits (i.e. the desired radar region is at or within the predefined limits) the CPU 202 defines the radar region of interest corresponding to the desired region of interest.

The CPU 202 may perform step S804 with knowledge of the complete desired region of interest.

Alternatively, the CPU 202 may perform the process 800 dynamically such that step S804 is performed multiples times on different portions of the desired radar region of interest and the process 800 loops back to S802 as the CPU 202 receives new portions of the desired region of interest.

The CPU 202 may use the measured reflected wave data output by the active reflected wave detector 206 to track a path travelled by a moving object to define a desired region of interest to correspond to the tracked path. During this tracking the CPU 202 may determine that while the object moves along the path the second sensing device ceases to detect the object and performs an action described above if and when the object ceases to be detected by the second sensing device.

In the example of the second sensing device being the motion sensor 204, the CPU 202 may determine that, while the object moves along the path, the motion sensor 204 has ceased to detect the object based on a predetermined period of time (e.g. 2 seconds) elapsing in which no motion is detected. The advantage of this embodiment is that the installer is made aware if, while trying to walk the path to define the desired region of interest, the motion sensor 204 “loses sight” of them. This may occur for example if they walk behind an object that blocks the sight of the motion sensor 204. It's important because if the desired region of interest was implemented as the region of interest and an intruder were to enter the premises at that location then the motion sensor 204 would not see them so would not trigger the active reflected wave detector 206 to turn on.

In the example of the second sensing device being the camera 208, the CPU 202 may perform image processing based object detection on images captured by the camera 208. In particular, the CPU 202 may determine that, while the object moves along the path, the camera 208 has ceased to detect the object based on a predetermined period of time elapsing in which the image processing reveals that no object is detected.

A further notification can be presented when the second sensing device senses the person so that the installer knows that they are again within the predefined limits. For example, the further notification can be presented when the motion sensor 204 again detects motion so that the installer knows that they are again seeable by the motion sensor 204.

Thus, a user can define a virtual fence that outlines a radar region of interest that is to be used by the active reflected wave detector 206 when triggered in response to the motion sensor 204, and the user knows that the motion sensor 204 can “see” all of the virtual fence.

In all of the embodiments described above, the active reflected wave detector 206 may provide both a ranging based output and a Doppler-based output based on measuring wave reflections from the environment. In these implementations, the active reflected wave detector 206 is configured to detection motion in a motion detection monitoring region in the environment, and a dedicated motion sensor 204 is not required.

Thus in the process 800, there may be a single sensing device (i.e. the active reflected wave detector 206) with the active reflected wave detector 206 being configured to output a first type of sensor signal to the CPU 202 (a ranging based output based on measuring wave reflections from the environment) and a second type of sensor signal to the CPU 202 (a Doppler-based output based on measuring wave reflections from the environment) that includes motion detection data that would have been otherwise provided by the motion sensor.

In embodiments of the process 800 where the motion sensor 204 is used, then the active reflected wave detector 206 could optionally, in addition to provide ranging data, also provide Doppler data).

The term “module,” as used herein generally represent software, firmware, hardware, or a combination thereof. In the case of a software implementation, the module represents program code that performs specified tasks when executed on a processor (e.g. CPU or CPUs). The program code can be stored in one or more computer readable memory devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Example, aspects of the present disclosure are defined by the following clauses:

A1. An apparatus for detecting an object in an environment, the apparatus comprising:
a camera, wherein the camera is controllable to switch from a first mode to a second mode to prepare the camera to capture an image; and
a processor, wherein the processor is arranged to receive motion detection data associated with a first monitoring region in said environment, and measured wave reflection data associated with a second monitoring region that is obtained by an active reflected wave detector, wherein the first monitoring region includes at least part of the second monitoring region and extends beyond the second monitoring region in at least one direction;
wherein in response to the processor detecting motion in the first monitoring region based on said motion detection data, the processor is configured to:
   activate the active reflected wave detector;
   determine whether a predetermined condition is met based on processing the measured wave reflection data; and
   if the predetermined condition is met, perform at least one operation related to camera image data.

A2. The apparatus according to clause A1, wherein the first monitoring region extends beyond the second monitoring region in at least one lateral direction.

A3. The apparatus according to clause A1 or A2, wherein a depth of the first monitoring region extends beyond a depth of the second monitoring region.

A4. The apparatus according to any preceding clause, wherein in at least one direction, the first monitoring region extends further from the active reflected wave detector than the second monitoring region extends from the active reflected wave detector.

A5. The apparatus according to any preceding clause, wherein the second monitoring region is entirely enclosed by the first monitoring region.

A6. The apparatus according to any preceding clause, wherein the first monitoring region extends beyond the second monitoring region by at least 1 metre in the at least one direction, preferably by at least 2 metres in the at least one direction.

A7. The apparatus according to any preceding clause, wherein the processor is configured to receive the camera image data from the camera, and the at least one operation comprises processing the camera image data for verification that the predetermined condition is met and/or for checking whether another condition is met.

A8. The apparatus according to any of clauses A1 to A6, wherein the processor is configured to receive the camera image data from the camera, and the at least one operation comprises transmitting the camera image data to a remote device for verification that the predetermined condition is met and/or for checking whether another condition is met.

A9. The apparatus according to any of clauses A1 to A6, wherein the processor is configured to receive the camera image data from the camera, and the at least one operation comprises transmitting message to a remote device informing the remote device of the capture of said camera image data.

A10. The apparatus according to clause A9, wherein in response to receiving a request from said remote device, the processor is configured to transmit the camera image data to the remote device.

A11. The apparatus according to any of clauses A7 to A10, wherein in response to the processor detecting motion in the first monitoring region the processor is further configured to control the camera to capture an image of said environment, and in response receive, from the camera, said camera image data that is associated with said image.

A12. The apparatus according to any of clauses A7 to A10, wherein the at least one operation comprises controlling the camera to capture of an image of said environment, and in response receive said camera image data that is associated with said image from the camera.

A13. The apparatus according to clause A12, wherein the at least one operation comprises controlling the camera to switch from the first mode to the second mode prior to capture of said image.

A14. The apparatus according to any of clauses A1 to A12, wherein the processor is configured to control the camera to switch from the first mode to the second mode in response to detecting motion in the first monitoring region.

A15. The apparatus according to clause A14, wherein the processor is configured to control the camera to switch from the first mode mode to the second mode before completion of said determination of whether the predetermined condition is met.

A16. The apparatus according to clause A14 or A15, wherein the processor is configured to control the camera to switch from the first mode mode to the second mode before commencement of said determination of whether the predetermined condition is met.

A17. The apparatus according to any of clauses A13 to A16, wherein the camera consumes more power when in the second mode than in the first mode.

A18. The apparatus according to any of preceding clause, wherein the active reflected wave detector is further operable to measure wave reflections from a third monitoring region in said environment, and the processor is further configured to:
process measured wave reflection data to detect that the object has left the third monitoring region, and in response cause the camera to switch from the second mode to a mode that consumes less power than the second mode.

A19. The apparatus according to clause A18, wherein the third monitoring region corresponds to the second monitoring region.

A20. The apparatus according to clause A18, wherein the third monitoring region extends beyond the second monitoring region in at least one direction.

A21. The apparatus according to clause A18 or A20, wherein the third monitoring region encompasses the second monitoring region.

A22. The apparatus according to any of clauses A18. A20 or A21, wherein the third monitoring region corresponds to the first monitoring region.

A23. The apparatus according to any of clauses A18, A20 or A21, wherein the third monitoring region extends beyond the first monitoring region in at least one direction.

A24. The apparatus according to any preceding clause, wherein the second monitoring region corresponds to at least one user defined region of interest that is within a maximum region that the active reflected wave detector is configured to monitor, wherein the active reflected wave detector is operable to detect a spatial position of the object in and/or with respect to said second monitoring region.

A25. The apparatus according to any of clauses A1 to A19, wherein the second monitoring region corresponds to a maximum region that the active reflected wave detector is configured to monitor, wherein the active reflected wave detector is operable to detect a spatial position of the object in and/or with respect to said second monitoring region.

A26. The apparatus according to any of clauses A20 to A25, wherein the third monitoring region corresponds to a maximum region that the active reflected wave detector is configured to monitor, wherein the active reflected wave detector is operable to detect a spatial position of the object in and/or with respect to said third monitoring region.

A27. The apparatus according to any of clauses A20 to A25, wherein the third monitoring region corresponds to at least one user defined region of interest that corresponds to, or is within, a maximum region that the active reflected wave detector is configured to monitor, wherein the active reflected wave detector is operable to detect a spatial position of the object in said third monitoring region.

A28. The apparatus according to any preceding clause, wherein the predetermined condition comprises that the object is detected in the second monitoring region.

A29. The apparatus according to clause A28, wherein the predetermined condition further comprises that the object is determined to be human.

A30. The apparatus according to any preceding clause, wherein the predetermined condition comprises that the object is located in a predetermined area within the second monitoring region.

A31. The apparatus according to any preceding clause, wherein the camera senses visible light.

A32. The apparatus according to clause A31, wherein the camera senses infrared light.

A33. The apparatus according to any preceding clause, wherein the active reflected wave detector is a ranging sensor.

A34. The apparatus according to clause A33, wherein the active reflected wave detector is a radar sensor.

A35. The apparatus according to any preceding clause, the apparatus further comprising a motion sensor configured to output said motion detection data.

A36. The apparatus according to any preceding clause, wherein the motion sensor is a passive infrared sensor.

A37. The apparatus according to any of clauses A1 to A34, wherein the active reflected wave detector is configured to output said motion detection data.

A38. The apparatus according to any preceding clause comprising a housing holding the processor, the housing additionally holding one or any combination of: the active reflected wave detector, and the camera.

A39. A computer implemented method for detecting an object in an environment, the method comprising:
receiving motion detection data associated with a first monitoring region in said environment;
in response detecting motion in the first monitoring region based on said motion detection data, the method further comprising:
   activating an active reflected wave detector;
   receiving measured wave reflection data associated with a second monitoring region obtained by the active reflected wave detector, wherein the first monitoring region includes at least part of the second monitoring region and extends beyond the second monitoring region in at least one direction;
   determining whether a predetermined condition is met based on processing the measured wave reflection data; and
   if the predetermined condition is met, performing at least one operation related to camera image data.

A40. A non-transitory computer-readable storage medium comprising instructions which, when executed by a processor that is coupled to an active reflected wave detector that is operable to measure wave reflections from the environment, causes the processor to:
receive motion detection data associated with a first monitoring region in said environment;
detect motion in the first monitoring region based on said motion detection data, and in response:
   activate the active reflected wave detector;
   receive measured wave reflection data associated with a second monitoring region obtained by the active reflected wave detector, wherein the first monitoring region includes at least part of the second monitoring region and extends beyond the second monitoring region in at least one direction;
   determine whether a predetermined condition is met based on processing the measured wave reflection data; and
   if the predetermined condition is met, performing at least one operation related to camera image data.

B1. An apparatus for detecting an object in an environment, the apparatus comprising:
a camera, wherein the camera is controllable to switch from a first mode to a second mode to prepare the camera to capture an image; and
a processor configured to:
   determine whether a predetermined condition is met based on processing measured wave reflection data obtained by an active reflected wave detector, the measured wave reflection data associated with wave reflections from a first monitoring region in said environment; and
   if the predetermined condition is met, perform at least one operation related to camera image data;
wherein the processor is further configured to:
   process measured wave reflection data that is associated with wave reflections from a second monitoring region in said environment to detect a predefined condition comprising that the object has left the second monitoring region, and in response to detection of the predefined condition cause the camera to switch from the second mode to a mode that consumes less power than the second mode.

B2. The apparatus according to clause B1, wherein the processor is configured to receive the camera image data from the camera, and the at least one operation comprises processing the camera image data for verification that the predetermined condition is met and/or for checking whether another condition is met.

B3. The apparatus according to clause B1, wherein the processor is configured to receive the camera image data from the camera, and the at least one operation comprises transmitting the camera image data to a remote device for verification that the predetermined condition is met and/or for checking whether another condition is met.

B4. The apparatus according to clause B1, wherein the processor is configured to receive the camera image data from the camera, and the at least one operation comprises transmitting message to a remote device informing the remote device of the capture of said camera image data.

B5. The apparatus according to clause B4, wherein in response to receiving a request from said remote device, the processor is configured to transmit the camera image data to the remote device.

B6. The apparatus according to any of clauses B2 to B5, wherein the at least one operation comprises controlling the camera to capture of an image of said environment, and in response receive said camera image data that is associated with said image from the camera.

B7. The apparatus according to clause B6, wherein the at least one operation comprises controlling the camera to switch from the first mode to the second mode prior to capture of said image.

B8. The apparatus according to any of clauses B1 to B7, wherein in response to the processor detecting an activity in said environment, the processor is further configured to control the camera to capture an image of said environment, and in response receive, from the camera, said camera image data that is associated with said image.

B9. The apparatus according to any of clauses B1 to B8, wherein in response to the processor detecting an activity in said environment, the processor is further configured to activate the active reflected wave detector to measure wave reflections from the environment to accrue said measured wave reflection data.

B10. The apparatus according to any of clauses B1 to B9, wherein in response to the processor detecting an activity in said environment, the processor is further configured to control the camera to switch from the first mode to the second mode.

B11. The apparatus according to clause B10, wherein the processor is configured to control the camera to switch from the first mode mode to the second mode before completion of said determination of whether the predetermined condition is met.

B12. The apparatus according to clause B10 or B11, wherein the processor is configured to control the camera to switch from the first mode mode to the second mode before commencement of said determination of whether the predetermined condition is met.

B13. The apparatus according to any of clauses B8 to B12, wherein said activity is motion detected in a motion detection monitoring region in said environment, and the processor is arranged to receive motion detection data associated with the motion detection monitoring region in said environment.

B14. The apparatus according to clause B13, the apparatus further comprising a motion sensor configured to output said motion detection data.

B15. The apparatus according to clause B14, wherein the motion sensor is a passive infrared sensor.

B16. The apparatus according to clause B13, wherein the active reflected wave detector is configured to output said motion detection data.

B17. The apparatus according to any of clauses B1 to B16, wherein the camera consumes more power when in the second mode than in the first mode.

B18. The apparatus according to any of clauses B1 to B17, wherein the second monitoring region extends beyond the first monitoring region in at least one direction.

B19. The apparatus according to any of clauses B1 to B18, wherein the second monitoring region encompasses the first monitoring region.

B20. The apparatus according to any of clauses B1 to B19, wherein the predetermined condition comprises that the object is detected in the first monitoring region.

B21. The apparatus according to clause B20, wherein the predetermined condition further comprises that the object is determined to be human.

B22. The apparatus according to any of clauses B1 to B21, wherein the predetermined condition comprises that the object is located in a predetermined area within the first monitoring region.

B23. The apparatus according to any of clauses B1 to B22, wherein the predefined condition comprises that the object has stayed outside of the second monitoring region for a predetermined amount of time.

B24. The apparatus according to any of clauses B1 to B23, wherein the predefined condition comprises that the object has left a third monitoring region that extends beyond the second monitoring region in at least one direction.

B25. The apparatus according to any of clauses B1 to B24, wherein the first monitoring region corresponds to at least one user defined region of interest that is within a maximum region that the active reflected wave detector is configured to monitor, wherein the active reflected wave detector is operable to detect a spatial position of the object in and/or with respect to said first monitoring region.

B26. The apparatus according to any of clauses B1 to B25, wherein the second monitoring region corresponds to at least one user defined region of interest that is within a maximum region that the active reflected wave detector is configured to monitor, wherein the active reflected wave detector is operable to detect a spatial position of the object in and/or with respect to said second monitoring region.

B27. The apparatus according to any of clauses B1 to B25, wherein the second monitoring region corresponds to a maximum region that the active reflected wave detector is configured to monitor, wherein the active reflected wave detector is operable to detect a spatial position of the object in and/or with respect to said second monitoring region.

B28. The apparatus according to clause B24, wherein the third monitoring region corresponds to a maximum region that the active reflected wave detector is configured to monitor, wherein the active reflected wave detector is operable to detect a spatial position of the object in and/or with respect to said third monitoring region.

B29. The apparatus according to any of clauses B1 to B28, wherein the camera senses visible light.

B30. The apparatus according to any of clauses B1 to B28, wherein the camera senses infrared light

B31. The apparatus according to any of clauses B1 to B30, wherein the active reflected wave detector is a ranging sensor.

B32. The apparatus according to clause B31, wherein the active reflected wave detector is a radar sensor.

B33. The apparatus according to any of clauses B1 to B32 comprising a housing holding the processor, the housing additionally holding one or any combination of: the active reflected wave detector, and the camera.

B34. A computer implemented method for detecting an object in an environment, the method comprising:
receiving measured wave reflection data obtained by an active reflected wave detector;
determining whether a predetermined condition is met based on processing measured wave reflection data that is associated with wave reflections from a first monitoring region in said environment;
if the predetermined condition is met, performing at least one operation related to camera image data; and
processing measured wave reflection data that is associated with wave reflections from a second monitoring region in said environment to detect a predefined condition comprising that the object has left the second monitoring region, and in response to detection of the predefined condition causing a camera, which is controllable to switch from a first mode to a second mode to prepare the camera to capture an image, to switch from the second mode to a mode that consumes less power than the second mode.

B35. A non-transitory computer-readable storage medium comprising instructions which, when executed by a processor that is coupled to an active reflected wave detector that is operable to measure wave reflections from an environment, causes the processor to:
receive measured wave reflection data obtained by the active reflected wave detector;
determine whether a predetermined condition is met based on processing measured wave reflection data that is associated with wave reflections from a first monitoring region in said environment;
if the predetermined condition is met, perform at least one operation related to camera image data; and
process measured wave reflection data that is associated with wave reflections from a second monitoring region in said environment to detect a predefined condition comprising that the object has left the second monitoring region, and in response to detection of the predefined condition cause a camera, which is controllable to switch from a first mode to a second mode to prepare the camera to capture an image, to switch from the second mode to a mode that consumes less power than the second mode.

C1. An apparatus for detecting an object in an environment, the apparatus comprising:
a processor coupled to at least one sensing device, the at least one sensing device configured to output a first type of sensor signal and a second type of sensor signal to the processor wherein the second type is different to the first type, the at least one sensing device comprising an active reflected wave detector that is operable to measure wave reflections from said environment to detect said object and output said first type of sensor signal, the processor configured to:
   receive an input that defines a desired region of interest in respect of the active reflected wave detector; and
   determine whether at least one part of the desired region extends beyond predefined limits, the predefined limits being correlated with viewable region limits associated with the at least one sensing device outputting said second type of sensor signal.

C2. The apparatus according to clause C1, wherein the at least one sensing device comprises a second sensing device different to the active reflected wave detector.

C3. The apparatus according to clause C2, wherein the second sensing device is a camera.

C4. The apparatus according to clause C2, wherein the second sensing device is a motion sensor.

C5. The apparatus according to clause C4, wherein the motion sensor is a passive infrared sensor.

C6. The apparatus according to any of clauses C2 to C5, wherein said predefined limits are further correlated with viewable region limits associated with a third sensing device that is of a type that is different to the active reflected wave detector and the second sensing device.

C7. The apparatus according to clause C1, wherein the active reflected wave detector outputs said first type of sensor signal and said second type of sensor signal.

C8. The apparatus according to any of clauses C1 to C7, wherein the predefined limits are correlated with said viewable region limits by the predefined limits being at the viewable region limits.

C9. The apparatus according to any of clauses C1 to C7, wherein the predefined limits are correlated with said viewable region limits by the predefined limits being within the viewable region limits.

C10. The apparatus according to any of clauses C1 to C9, wherein the input is wave reflection data from the active reflected wave detector, and the processor is further configured to:
process the wave reflection data to track a path travelled by a moving object in said environment; and
define at least part of the desired region of interest to correspond to the tracked path.

C11. The apparatus according to clause C10, wherein said determination of whether at least one part of the desired region extends beyond predefined limits is performed whilst said moving object moves along said path, and the processor is configured to:
determine that the at least one part of the desired region extends beyond the predefined limits based on the second sensing signal; and
generate a notification in response to said determination.

C12. The apparatus according to clause C11, wherein after output of said notification, the processor is further configured to:
determine that at least one further part of the desired region is at, or within, the predefined limits based on the output of the second sensing signal, and in response, generate a further notification.

C13. The apparatus according to any of clauses C10 to C12, wherein the moving object is a person.

C14. The apparatus according to any of clauses C10 to C12, wherein the moving object is a reflector carried by a person.

C15. The apparatus according to any of clauses C1 to C9, wherein the input is wave reflection data from the active reflected wave detector, and the processor is further configured to process the wave reflection data to determine locations of reflectors placed in the environment by a user to define the desired region of interest.

C16. The apparatus according to any of clauses C1 to C9, wherein the input is received from a remote computing device, the desired region of interest being specified by a user using the remote computing device.

C17. The apparatus according to any of clauses C1 to C16, wherein in response to a determination that the at least one part of the desired region extends beyond the predefined limits, the processor is configured to generate a notification.

C18. The apparatus according to clause C17, wherein the apparatus comprises an audio output device and the processor is configured to transmit the notification to the audio output device for audible output by the audio output device.

C19. The apparatus according to clause C17 or C18, wherein the apparatus comprises a display and the processor is configured to transmit the notification to the display for visual output by the display.

C20. The apparatus according to clause C16, wherein in response to a determination that the at least one part of the desired region extends beyond the predefined limits, the processor is configured to generate a notification and transmit the notification to the remote computing device.

C21. The apparatus according to any of clauses C17 to C20, wherein the notification indicates a location corresponding to the at least one part of the desired region that extends beyond the predefined limits.

C22. The apparatus according to any of clauses C1 to C21, wherein in response to a determination that the at least one part of the desired region extends beyond the predefined limits, the processor is configured to define a region of interest that corresponds to the desired region of interest, wherein the at least one part is limited by the processor to be at the predefined limits.

C23. The apparatus according to any of clauses C1 to C21, wherein in response to a determination that the at least one part of the desired region extends beyond the predefined limits, the processor is configured to define a region of interest that corresponds to the desired region of interest, wherein the at least one part is limited by the processor to be within the predefined limits.

C24. The apparatus according to clause C23, wherein the processor is configured to define the region of interest such that the predefined limits associated with the at least one sensing device outputting said second type of sensor signal includes at least part of the defined region of interest and extend beyond the defined region of interest in at least one direction.

C25. The apparatus according to any of clauses C1 to C24, wherein in response to a determination that all of the desired region is at or within the predefined limits, the processor is configured to define a region of interest that corresponds to the desired region of interest.

C26. The apparatus according to any of clauses C22 to C25, wherein the processor is configured to process wave reflections from the defined region of interest in said environment to detect said object.

C27. The apparatus according to any of clauses C22 to C26, wherein the processor is configured to process wave reflections from the defined region of interest in said environment to determine a location of said object in the defined region of interest of said environment.

C28. The apparatus according to any of clauses C1 to C27, wherein the active reflected wave detector is a ranging sensor.

C29. The apparatus according to clause C28, wherein the active reflected wave detector is a radar sensor.

C30. A computer implemented method for detecting an object in an environment, the method comprising:
receiving an input that defines a desired region of interest in respect of an active reflected wave detector that is operable to measure wave reflections from said environment to detect said object and output a first type of sensor signal; and
determining whether at least one part of the desired region extends beyond predefined limits, the predefined limits being correlated with viewable region limits associated with at least one sensing device outputting a second type of sensor signal, wherein the second type is different to the first type, the at least one sensing device comprising said active reflected wave detector.

C31. A non-transitory computer-readable storage medium comprising instructions which, when executed by a processor, that is coupled to at least one sensing device that is configured to output a first type of sensor signal and a second type of sensor signal to the processor wherein the second type is different to the first type, the at least one sensing device comprising an active reflected wave detector that is operable to measure wave reflections from said environment to detect said object and output said first type of sensor signal, causes the processor to:
receive an input that defines a desired region of interest in respect of the active reflected wave detector; and
determine whether at least one part of the desired region extends beyond predefined limits, the predefined limits being correlated with viewable region limits associated with the at least one sensing device outputting said second type of sensor signal.

1-40. (canceled)

41. An apparatus for detecting an object in an environment, the apparatus comprising:
a camera, wherein the camera is controllable to switch from a first mode to a second mode to prepare the camera to capture an image; and
a processor configured to:
determine whether a predetermined condition is met based on processing measured wave reflection data obtained by an active reflected wave detector, the measured wave reflection data associated with wave reflections from a first monitoring region in said environment; and
if the predetermined condition is met, perform at least one operation related to camera image data;
wherein the processor is further configured to:
process measured wave reflection data that is associated with wave reflections from a second monitoring region in said environment to detect a predefined condition comprising that the object has left the second monitoring region, and in response to detection of the predefined condition cause the camera to switch from the second mode to a mode that consumes less power than the second mode.

42. The apparatus according to claim 41, wherein the processor is configured to receive the camera image data from the camera, and the at least one operation comprises any one of:
processing the camera image data for verification that the predetermined condition is met and/or for checking whether another condition is met;
transmitting the camera image data to a remote device for verification that the predetermined condition is met and/or for checking whether another condition is met; and
transmitting message to a remote device informing the remote device of the capture of said camera image data.

43-45. (canceled)

46. The apparatus according to claim 42, wherein the at least one operation comprises controlling the camera to capture of an image of said environment, and in response receive said camera image data that is associated with said image from the camera.

47. (canceled)

48. The apparatus according to claim 41, wherein in response to the processor detecting an activity in said environment, the processor is further configured to control the camera to capture an image of said environment, and in response receive, from the camera, said camera image data that is associated with said image.

49. The apparatus according to claim 41, wherein in response to the processor detecting an activity in said environment, the processor is further configured to activate the active reflected wave detector to measure wave reflections from the environment to accrue said measured wave reflection data.

50. The apparatus according to claim 41, wherein in response to the processor detecting an activity in said environment, the processor is further configured to control the camera to switch from the first mode to the second mode.

51-52. (canceled)

53. The apparatus according to claim 48, wherein said activity is motion detected in a motion detection monitoring region in said environment, and the processor is arranged to receive motion detection data associated with the motion detection monitoring region in said environment.

54. The apparatus according to claim 53, the apparatus further comprising a motion sensor configured to output said motion detection data.

55-56. (canceled)

57. The apparatus according to claim 41, wherein the camera consumes more power when in the second mode than in the first mode.

58. The apparatus according to claim 41, wherein the second monitoring region extends beyond the first monitoring region in at least one direction.

59. The apparatus according to claim 41, wherein the second monitoring region encompasses the first monitoring region.

60. The apparatus according to claim 41, wherein the predetermined condition comprises that the object is detected in the first monitoring region.

61. The apparatus according to claim 60, wherein the predetermined condition further comprises that the object is determined to be human.

62. The apparatus according to claim 41, wherein the predetermined condition comprises that the object is located in a predetermined area within the first monitoring region.

63. The apparatus according to claim 41, wherein the predefined condition comprises that the object has stayed outside of the second monitoring region for a predetermined amount of time.

64. The apparatus according to claim 41, wherein the predefined condition comprises that the object has left a third monitoring region that extends beyond the second monitoring region in at least one direction.

65-70. (canceled)

71. The apparatus according to claim 41, wherein the active reflected wave detector is a ranging sensor.

72. (canceled)

73. The apparatus according to claim 41 comprising a housing holding the processor, the housing additionally holding the active reflected wave detector, and the camera.

74. A computer implemented method for detecting an object in an environment, the method comprising:
receiving measured wave reflection data obtained by an active reflected wave detector;
determining whether a predetermined condition is met based on processing measured wave reflection data that is associated with wave reflections from a first monitoring region in said environment;
if the predetermined condition is met, performing at least one operation related to camera image data; and
processing measured wave reflection data that is associated with wave reflections from a second monitoring region in said environment to detect a predefined condition comprising that the object has left the second monitoring region, and in response to detection of the predefined condition causing a camera, which is controllable to switch from a first mode to a second mode to prepare the camera to capture an image, to switch from the second mode to a mode that consumes less power than the second mode.

75. A non-transitory computer-readable storage medium comprising instructions which, when executed by a processor that is coupled to an active reflected wave detector that is operable to measure wave reflections from an environment, causes the processor to:
receive measured wave reflection data obtained by the active reflected wave detector;
determine whether a predetermined condition is met based on processing measured wave reflection data that is associated with wave reflections from a first monitoring region in said environment;
if the predetermined condition is met, perform at least one operation related to camera image data; and
process measured wave reflection data that is associated with wave reflections from a second monitoring region in said environment to detect a predefined condition comprising that the object has left the second monitoring region, and in response to detection of the predefined condition cause a camera, which is controllable to switch from a first mode to a second mode to prepare the camera to capture an image, to switch from the second mode to a mode that consumes less power than the second mode.

76-106. (canceled)
